(19) United States
(12) Patent Application Publication
(10) Pub. No.: US 2024/0380922 A1
(43) Pub. Date: Nov. 14, 2024

(54) GPM MOTION REFINEMENT

(71) Applicants: Beijing Bytedance Network Technology Co., Ltd., Beijing (CN); Bytedance Inc., Los Angeles, CA (US)

(72) Inventors: Zhipin DENG, Beijing (CN); Kai ZHANG, Los Angeles, CA (US); Li ZHANG, Los Angeles, CA (US)

(21) Appl. No.: 18/286,194

(22) PCT Filed: Apr. 8, 2022
(86) PCT No.: PCT/CN2022/085828

§ 371 Date: Oct. 9, 2023

(30) Foreign Application Priority Data
Apr. 10, 2021 (WO) PCT/CN2021/086308

(51) Int. Cl. H04N 19/56; H04N 19/176; H04N 19/184

(52) U.S. Cl. CPC H04N 19/56; H04N 19/176; H04N 19/184

(57) ABSTRACT

It provides a solution for video processing. A method for video processing is proposed. The method comprises: determining motion information for a video block of a video by conducting a refinement process on at least one of a first merge candidate or a second merge candidate for the video block, the second merge candidate being generated based on the first merge candidate; and performing a conversion between the video block and a bitstream of the video based on the motion information. Compared with the conventional solution, the proposed method can advantageously improve the coding performance.

### FIELD

Embodiments of the present disclosure relates generally to video coding techniques, and more particularly, to reference structure for video coding.

### BACKGROUND

In nowadays, digital video capabilities are being applied in various aspects of peoples' lives. Multiple types of video compression technologies, such as MPEG-2, MPEG-4, ITU-TH.263, ITU-TH.264/MPEG-4 Part 10 Advanced Video Coding (AVC), ITU-TH.265 high efficiency video coding (HEVC) standard, versatile video coding (VVC) standard, have been proposed for video encoding/decoding. However, the coding performance of VVC needs to be further improved.

### SUMMARY

Embodiments of the present disclosure provide a solution for video processing.

In a first aspect, a method for video processing is proposed. The method comprises: determining motion information for a video block of a video by conducting a refinement process on at least one of a first merge candidate or a second merge candidate for the video block, the second merge candidate being generated based on the first merge candidate; and performing a conversion between the video block and a bitstream of the video based on the motion information. The method in accordance with the first aspect of the present disclosure generates motion information by refining a regular merge candidate. Compared with the conventional solution, the proposed method can advantageously improve the coding performance.

In a second aspect, an apparatus device for processing video data is proposed. The apparatus a processor and a non-transitory memory with instructions thereon, wherein the instructions upon execution by the processor, cause the processor to: determine motion information for a video block of a video by conducting a refinement process on at least one of a first merge candidate or a second merge candidate for the video block, the second merge candidate being generated based on the first merge candidate; and perform a conversion between the video block and a bitstream of the video based on the motion information.

In a third aspect, a non-transitory computer-readable storage medium is proposed. The non-transitory computer-readable storage medium storing instructions that cause a processor to perform a method in accordance with the first aspect of the present disclosure.

In a fourth aspect, a non-transitory computer-readable recording medium is proposed. The non-transitory computer-readable recording medium stores a bitstream of a video which is generated by a method performed by a video processing apparatus, wherein the method comprises: determining motion information for a video block of a video by conducting a refinement process on at least one of a first merge candidate or a second merge candidate for the video block, the second merge candidate being generated based on the first merge candidate; generating the bitstream based on the motion information.

In a fifth aspect, a method for storing bitstream of a video is proposed. The method comprises: determining motion information for a video block of a video by conducting a refinement process on at least one of a first merge candidate or a second merge candidate for the video block, the second merge candidate being generated based on the first merge candidate; generating the bitstream based on the motion information; and storing the bitstream in a non-transitory computer-readable recording medium.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

FIG. 1 illustrates a block diagram that illustrates an example video coding system, in accordance with some embodiments of the present disclosure;

FIG. 2 illustrates a block diagram that illustrates a first example video encoder, in accordance with some embodiments of the present disclosure;

FIG. 3 illustrates a block diagram that illustrates an example video decoder, in accordance with some embodiments of the present disclosure;

FIG. 4 illustrates positions of spatial merge candidate;

FIG. 5 illustrates candidate pairs considered for redundancy check of spatial merge candidates;

FIG. 6 illustrates motion vector scaling for temporal merge candidate;

FIG. 7 illustrates candidate positions for temporal merge candidate, C₀ and C₁;

FIG. 8 illustrates MMVD Search Point;

FIG. 9 illustrates decoding side motion vector refinement;

FIG. 10 illustrates examples of the GPM splits grouped by identical angles;

FIG. 11 illustrates uni-prediction MV selection for geometric partitioning mode;

FIG. 12 illustrates exemplified generation of a bending weight w_0 using geometric partitioning mode;

FIG. 13 illustrates a flowchart of a method for video processing in accordance with some embodiments of the present disclosure; and

FIG. 14 illustrates a block diagram of a computing device in which various embodiments of the present disclosure can be implemented.

Throughout the drawings, the same or similar reference numerals usually refer to the same or similar elements.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### Example Environment

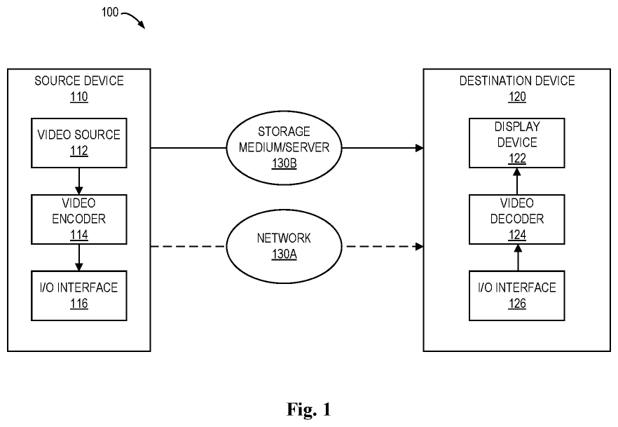

FIG. 1 is a block diagram that illustrates an example video coding system 100 that may utilize the techniques of this disclosure. As shown, the video coding system 100 may include a source device 110 and a destination device 120. The source device 110 can be also referred to as a video encoding device, and the destination device 120 can be also referred to as a video decoding device. In operation, the source device 110 can be configured to generate encoded video data and the destination device 120 can be configured to decode the encoded video data generated by the source device 110. The source device 110 may include a video source 112, a video encoder 114, and an input/output (I/O) interface 116.

The video source 112 may include a source such as a video capture device. Examples of the video capture device include, but are not limited to, an interface to receive video data from a video content provider, a computer graphics system for generating video data, and/or a combination thereof.

The video data may comprise one or more pictures. The video encoder 114 encodes the video data from the video source 112 to generate a bitstream. The bitstream may include a sequence of bits that form a coded representation of the video data. The bitstream may include coded pictures and associated data. The coded picture is a coded representation of a picture. The associated data may include sequence parameter sets, picture parameter sets, and other syntax structures. The I/O interface 116 may include a modulator/demodulator and/or a transmitter. The encoded video data may be transmitted directly to destination device 120 via the I/O interface 116 through the network 130A. The encoded video data may also be stored onto a storage medium/server 130B for access by destination device 120.

The destination device 120 may include an I/O interface 126, a video decoder 124, and a display device 122. The I/O interface 126 may include a receiver and/or a modem. The I/O interface 126 may acquire encoded video data from the source device 110 or the storage medium/server 130B. The video decoder 124 may decode the encoded video data. The display device 122 may display the decoded video data to a user. The display device 122 may be integrated with the destination device 120, or may be external to the destination device 120 which is configured to interface with an external display device.

The video encoder 114 and the video decoder 124 may operate according to a video compression standard, such as the High Efficiency Video Coding (HEVC) standard, Versatile Video Coding (VVC) standard and other current and/or further standards.

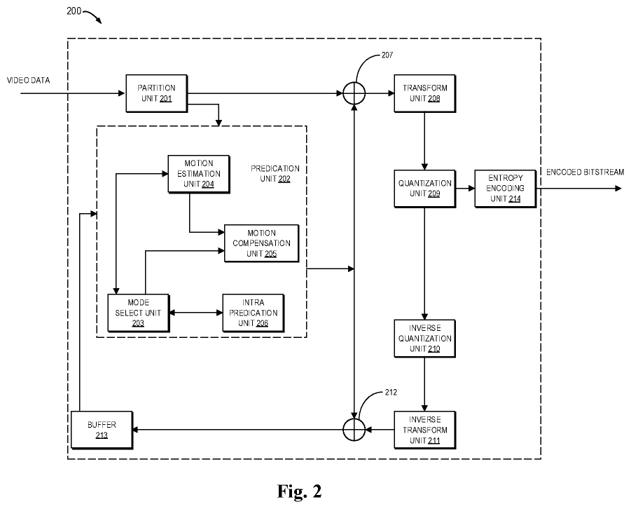

FIG. 2 is a block diagram illustrating an example of a video encoder 200, which may be an example of the video encoder 114 in the system 100 illustrated in FIG. 1, in accordance with some embodiments of the present disclosure.

The video encoder 200 may be configured to implement any or all of the techniques of this disclosure. In the example of FIG. 2, the video encoder 200 includes a plurality of functional components. The techniques described in this disclosure may be shared among the various components of the video encoder 200. In some examples, a processor may be configured to perform any or all of the techniques described in this disclosure.

In some embodiments, the video encoder 200 may include a partition unit 201, a predication unit 202 which may include a mode select unit 203, a motion estimation unit 204, a motion compensation unit 205 and an intra-prediction unit 206, a residual generation unit 207, a transform unit 208, a quantization unit 209, an inverse quantization unit 210, an inverse transform unit 211, a reconstruction unit 212, a buffer 213, and an entropy encoding unit 214.

In other examples, the video encoder 200 may include more, fewer, or different functional components. In an example, the predication unit 202 may include an intra block copy (IBC) unit. The IBC unit may perform predication in an IBC mode in which at least one reference picture is a picture where the current video block is located.

Furthermore, although some components, such as the motion estimation unit 204 and the motion compensation unit 205, may be integrated, but are represented in the example of FIG. 2 separately for purposes of explanation.

The partition unit 201 may partition a picture into one or more video blocks. The video encoder 200 and the video decoder 300 may support various video block sizes.

The mode select unit 203 may select one of the coding modes, intra or inter, e.g., based on error results, and provide the resulting intra-coded or inter-coded block to a residual generation unit 207 to generate residual block data and to a reconstruction unit 212 to reconstruct the encoded block for use as a reference picture. In some examples, the mode select unit 203 may select a combination of intra and inter predication (CIIP) mode in which the predication is based on an inter predication signal and an intra predication signal. The mode select unit 203 may also select a resolution for a motion vector (e.g., a sub-pixel or integer pixel precision) for the block in the case of inter-predication.

To perform inter prediction on a current video block, the motion estimation unit 204 may generate motion information for the current video block by comparing one or more reference frames from buffer 213 to the current video block. The motion compensation unit 205 may determine a predicted video block for the current video block based on the motion information and decoded samples of pictures from the buffer 213 other than the picture associated with the current video block.

The motion estimation unit 204 and the motion compensation unit 205 may perform different operations for a current video block, for example, depending on whether the current video block is in an I-slice, a P-slice, or a B-slice. As used herein, an “I-slice” may refer to a portion of a picture composed of macroblocks, all of which are based upon macroblocks within the same picture. Further, as used herein, in some aspects, “P-slices” and “B-slices” may refer to portions of a picture composed of macroblocks that are not dependent on macroblocks in the same picture.

In some examples, the motion estimation unit 204 may perform uni-directional prediction for the current video block, and the motion estimation unit 204 may search reference pictures of list 0 or list 1 for a reference video block for the current video block. The motion estimation unit 204 may then generate a reference index that indicates the reference picture in list 0 or list 1 that contains the reference video block and a motion vector that indicates a spatial displacement between the current video block and the reference video block. The motion estimation unit 204 may output the reference index, a prediction direction indicator, and the motion vector as the motion information of the current video block. The motion compensation unit 205 may generate the predicted video block of the current video block based on the reference video block indicated by the motion information of the current video block.

Alternatively, in other examples, the motion estimation unit 204 may perform bi-directional prediction for the current video block. The motion estimation unit 204 may search the reference pictures in list 0 for a reference video block for the current video block and may also search the reference pictures in list 1 for another reference video block for the current video block. The motion estimation unit 204 may then generate reference indexes that indicate the reference pictures in list 0 and list 1 containing the reference video blocks and motion vectors that indicate spatial displacements between the reference video blocks and the current video block. The motion estimation unit 204 may output the reference indexes and the motion vectors of the current video block as the motion information of the current video block. The motion compensation unit 205 may generate the predicted video block of the current video block based on the reference video blocks indicated by the motion information of the current video block.

In some examples, the motion estimation unit 204 may output a full set of motion information for decoding processing of a decoder. Alternatively, in some embodiments, the motion estimation unit 204 may signal the motion information of the current video block with reference to the motion information of another video block. For example, the motion estimation unit 204 may determine that the motion information of the current video block is sufficiently similar to the motion information of a neighboring video block.

In one example, the motion estimation unit 204 may indicate, in a syntax structure associated with the current video block, a value that indicates to the video decoder 300 that the current video block has the same motion information as the another video block.

In another example, the motion estimation unit 204 may identify, in a syntax structure associated with the current video block, another video block and a motion vector difference (MVD). The motion vector difference indicates a difference between the motion vector of the current video block and the motion vector of the indicated video block. The video decoder 300 may use the motion vector of the indicated video block and the motion vector difference to determine the motion vector of the current video block.

As discussed above, video encoder 200 may predictively signal the motion vector. Two examples of predictive signaling techniques that may be implemented by video encoder 200 include advanced motion vector predication (AMVP) and merge mode signaling.

The intra prediction unit 206 may perform intra prediction on the current video block. When the intra prediction unit 206 performs intra prediction on the current video block, the intra prediction unit 206 may generate prediction data for the current video block based on decoded samples of other video blocks in the same picture. The prediction data for the current video block may include a predicted video block and various syntax elements.

The residual generation unit 207 may generate residual data for the current video block by subtracting (e.g., indicated by the minus sign) the predicted video block (s) of the current video block from the current video block. The residual data of the current video block may include residual video blocks that correspond to different sample components of the samples in the current video block.

In other examples, there may be no residual data for the current video block for the current video block, for example in a skip mode, and the residual generation unit 207 may not perform the subtracting operation.

The transform processing unit 208 may generate one or more transform coefficient video blocks for the current video block by applying one or more transforms to a residual video block associated with the current video block.

After the transform processing unit 208 generates a transform coefficient video block associated with the current video block, the quantization unit 209 may quantize the transform coefficient video block associated with the current video block based on one or more quantization parameter (QP) values associated with the current video block.

The inverse quantization unit 210 and the inverse transform unit 211 may apply inverse quantization and inverse transforms to the transform coefficient video block, respectively, to reconstruct a residual video block from the transform coefficient video block. The reconstruction unit 212 may add the reconstructed residual video block to corresponding samples from one or more predicted video blocks generated by the predication unit 202 to produce a reconstructed video block associated with the current video block for storage in the buffer 213.

After the reconstruction unit 212 reconstructs the video block, loop filtering operation may be performed to reduce video blocking artifacts in the video block.

The entropy encoding unit 214 may receive data from other functional components of the video encoder 200. When the entropy encoding unit 214 receives the data, the entropy encoding unit 214 may perform one or more entropy encoding operations to generate entropy encoded data and output a bitstream that includes the entropy encoded data.

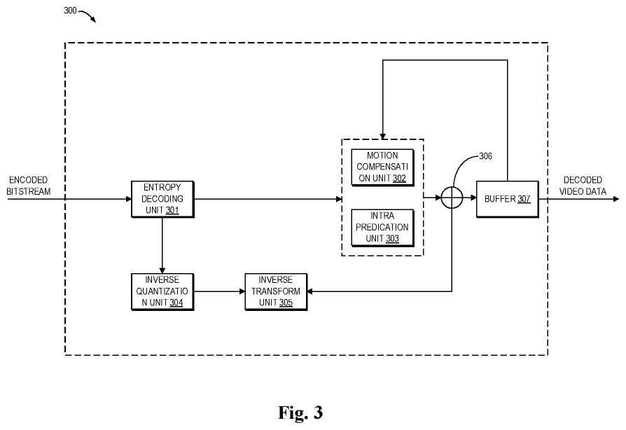

FIG. 3 is a block diagram illustrating an example of a video decoder 300, which may be an example of the video decoder 124 in the system 100 illustrated in FIG. 1, in accordance with some embodiments of the present disclosure.

The video decoder 300 may be configured to perform any or all of the techniques of this disclosure. In the example of FIG. 3, the video decoder 300 includes a plurality of functional components. The techniques described in this disclosure may be shared among the various components of the video decoder 300. In some examples, a processor may be configured to perform any or all of the techniques described in this disclosure.

In the example of FIG. 3, the video decoder 300 includes an entropy decoding unit 301, a motion compensation unit 302, an intra prediction unit 303, an inverse quantization unit 304, an inverse transformation unit 305, and a reconstruction unit 306 and a buffer 307. The video decoder 300 may, in some examples, perform a decoding pass generally reciprocal to the encoding pass described with respect to video encoder 200.

The entropy decoding unit 301 may retrieve an encoded bitstream. The encoded bitstream may include entropy coded video data (e.g., encoded blocks of video data). The entropy decoding unit 301 may decode the entropy coded video data, and from the entropy decoded video data, the motion compensation unit 302 may determine motion information including motion vectors, motion vector precision, reference picture list indexes, and other motion information. The motion compensation unit 302 may, for example, determine such information by performing the AMVP and merge mode. AMVP is used, including derivation of several most probable candidates based on data from adjacent PBs and the reference picture. Motion information typically includes the horizontal and vertical motion vector displacement values, one or two reference picture indices, and, in the case of prediction regions in B slices, an identification of which reference picture list is associated with each index. As used herein, in some aspects, a “merge mode” may refer to deriving the motion information from spatially or temporally neighboring blocks.

The motion compensation unit 302 may produce motion compensated blocks, possibly performing interpolation based on interpolation filters. Identifiers for interpolation filters to be used with sub-pixel precision may be included in the syntax elements.

The motion compensation unit 302 may use the interpolation filters as used by the video encoder 200 during encoding of the video block to calculate interpolated values for sub-integer pixels of a reference block. The motion compensation unit 302 may determine the interpolation filters used by the video encoder 200 according to the received syntax information and use the interpolation filters to produce predictive blocks.

The motion compensation unit 302 may use at least part of the syntax information to determine sizes of blocks used to encode frame(s) and/or slice(s) of the encoded video sequence, partition information that describes how each macroblock of a picture of the encoded video sequence is partitioned, modes indicating how each partition is encoded, one or more reference frames (and reference frame lists) for each inter-encoded block, and other information to decode the encoded video sequence. As used herein, in some aspects, a “slice” may refer to a data structure that can be decoded independently from other slices of the same picture, in terms of entropy coding, signal prediction, and residual signal reconstruction. A slice can either be an entire picture or a region of a picture.

The intra prediction unit 303 may use intra prediction modes for example received in the bitstream to form a prediction block from spatially adjacent blocks. The inverse quantization unit 305 inverse quantizes, i.e., de-quantizes, the quantized video block coefficients provided in the bitstream and decoded by entropy decoding unit 301. The inverse transform unit 305 applies an inverse transform.

The reconstruction unit 306 may obtain the decoded blocks, e.g., by summing the residual blocks with the corresponding prediction blocks generated by the motion compensation unit 202 or intra-prediction unit 303. If desired, a deblocking filter may also be applied to filter the decoded blocks in order to remove blockiness artifacts. The decoded video blocks are then stored in the buffer 307, which provides reference blocks for subsequent motion compensation/intra predication and also produces decoded video for presentation on a display device.

Some exemplary embodiments of the present disclosure will be described in detailed hereinafter. It should be understood that section headings are used in the present document to facilitate ease of understanding and do not limit the embodiments disclosed in a section to only that section. Furthermore, while certain embodiments are described with reference to Versatile Video Coding or other specific video codecs, the disclosed techniques are applicable to other video coding technologies also. Furthermore, while some embodiments describe video coding steps in detail, it will be understood that corresponding steps decoding that undo the coding will be implemented by a decoder. Furthermore, the term video processing encompasses video coding or compression, video decoding or decompression and video transcoding in which video pixels are represented from one compressed format into another compressed format or at a different compressed bitrate.

### 1. SUMMARY

This invention is related to video coding technologies. Specifically, it is about inter prediction and related techniques in video coding. It may be applied to the existing video coding standard like HEVC, VVC, and etc. It may be also applicable to future video coding standards or video codec.

### 2. BACKGROUND

Video coding standards have evolved primarily through the development of the well-known ITU-T and ISO/IEC standards. The ITU-T produced H.261 and H.263, ISO/IEC produced MPEG-1 and MPEG-4 Visual, and the two organizations jointly produced the H.262/MPEG-2 Video and H.264/MPEG-4 Advanced Video Coding (AVC) and H.265/HEVC (ITU-T and ISO/IEC, “High efficiency video coding”, Rec. ITU-T H.265|ISO/IEC 23008-2 (in force edition)) standards. Since H.262, the video coding standards are based on the hybrid video coding structure wherein temporal prediction plus transform coding are utilized. To explore the future video coding technologies beyond HEVC, the Joint Video Exploration Team (JVET) was founded by VCEG and MPEG jointly in 2015. The JVET meeting is concurrently held once every quarter, and the new video coding standard was officially named as Versatile Video Coding (VVC) in the April 2018 JVET meeting, and the first version of VVC test model (VTM) was released at that time. The VVC working draft and test model VTM are then updated after every meeting. The VVC project achieved technical completion (FDIS) at the July 2020 meeting.

2.1. Existing Coding Tools (Extracted from JVET-R2002)

### 2.1.1. Extended Merge Prediction

In VVC, the merge candidate list is constructed by including the following five types of candidates in order:
1) Spatial MVP from spatial neighbor CUs
2) Temporal MVP from collocated CUs
3) History-based MVP from an FIFO table
4) Pairwise average MVP
5) Zero MVs.

The size of merge list is signalled in sequence parameter set header and the maximum allowed size of merge list is 6. For each CU code in merge mode, an index of best merge candidate is encoded using truncated unary binarization (TU). The first bin of the merge index is coded with context and bypass coding is used for other bins.

The derivation process of each category of merge candidates is provided in this session. As done in HEVC, VVC also supports parallel derivation of the merging candidate lists for all CUs within a certain size of area.

### 2.1.1.1. Spatial Candidates Derivation

The derivation of spatial merge candidates in VVC is same to that in HEVC except the positions of first two merge candidates are swapped. A maximum of four merge candidates are selected among candidates located in the positions depicted in FIG. 4. The order of derivation is B₀, A₀, B₁, A₁ and B₂. Position B₂ is considered only when one or more than one CUs of position B₀, A₀, B₁, A₁ are not available (e.g. because it belongs to another slice or tile) or is intra coded. After candidate at position A₁ is added, the addition of the remaining candidates is subject to a redundancy check which ensures that candidates with same motion information are excluded from the list so that coding efficiency is improved. To reduce computational complexity, not all possible candidate pairs are considered in the mentioned redundancy check. Instead only the pairs linked with an arrow in FIG. 5 are considered and a candidate is only added to the list if the corresponding candidate used for redundancy check has not the same motion information.

### 2.1.1.2. Temporal Candidates Derivation

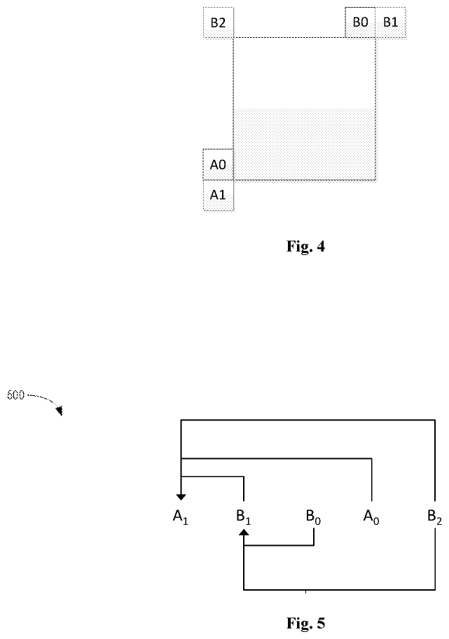

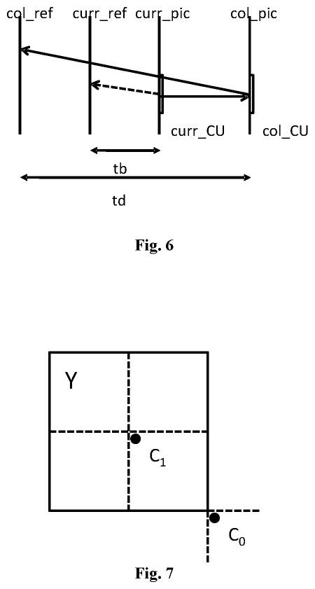

In this step, only one candidate is added to the list. Particularly, in the derivation of this temporal merge candidate, a scaled motion vector is derived based on co-located CU belonging to the collocated referenncee picture. The reference picture list to be used for derivation of the co-located CU is explicitly signalled in the slice header. The scaled motion vector for temporal merge candidate is obtained as illustrated by the dotted line in FIG. 6, which is scaled from the motion vector of the co-located CU using the POC distances, tb and td, where tb is defined to be the POC difference between the reference picture of the current picture and the current picture and td is defined to be the POC difference between the reference picture of the co-located picture and the co-located picture. The reference picture index of temporal merge candidate is set equal to zero.

The position for the temporal candidate is selected between candidates C₀ and C₁, as depicted in FIG. 7 If CU at position C₀ is not available, is intra coded, or is outside of the current row of CTUs, position C₁ is used. Otherwise, position C₀ is used in the derivation of the temporal merge candidate.

### 2.1.1.3. History-Based Merge Candidates Derivation

The history-based MVP (HMVP) merge candidates are added to merge list after the spatial MVP and TMVP. In this method, the motion information of a previously coded block is stored in a table and used as MVP for the current CU. The table with multiple HMVP candidates is maintained during the encoding/decoding process. The table is reset (emptied) when a new CTU row is encountered. Whenever there is a non-subblock inter-coded CU, the associated motion information is added to the last entry of the table as a new HMVP candidate.

The HMVP table size S is set to be 6, which indicates up to 6 History-based MVP (HMVP) candidates may be added to the table. When inserting a new motion candidate to the table, a constrained first-in-first-out (FIFO) rule is utilized wherein redundancy check is firstly applied to find whether there is an identical HMVP in the table. If found, the identical HMVP is removed from the table and all the HMVP candidates afterwards are moved forward, HMVP candidates could be used in the merge candidate list construction process. The latest several HMVP candidates in the table are checked in order and inserted to the candidate list after the TMVP candidate. Redundancy check is applied on the HMVP candidates to the spatial or temporal merge candidate.

To reduce the number of redundancy check operations, the following simplifications are introduced:
1. Number of HMPV candidates is used for merge list generation is set as (N<=4)? M: (8−N), wherein N indicates number of existing candidates in the merge list and M indicates number of available HMVP candidates in the table.
2. Once the total number of available merge candidates reaches the maximally allowed merge candidates minus 1, the merge candidate list construction process from HMVP is terminated.

### 2.1.1.4. Pair-Wise Average Merge Candidates Derivation

Pairwise average candidates are generated by averaging predefined pairs of candidates in the existing merge candidate list, and the predefined pairs are defined as {(0, 1), (0, 2), (1, 2), (0, 3), (1, 3), (2, 3)}, where the numbers denote the merge indices to the merge candidate list. The averaged motion vectors are calculated separately for each reference list. If both motion vectors are available in one list, these two motion vectors are averaged even when they point to different reference pictures; if only one motion vector is available, use the one directly; if no motion vector is available, keep this list invalid. When the merge list is not full after pair-wise average merge candidates are added, the zero MVPs are inserted in the end until the maximum merge candidate number is encountered.

### 2.1.1.5. Merge Estimation Region

Merge estimation region (MER) allows independent derivation of merge candidate list for the CUs in the same merge estimation region (MER). A candidate block that is within the same MER to the current CU is not included for the generation of the merge candidate list of the current CU. In addition, the updating process for the history-based motion vector predictor candidate list is updated only if (xCb+cbWidth)>>Log2ParMrgLevel is greater than xCb>>Log2ParMrgLevel and (yCb+cbHeight)>>Log2ParMrgLevel is great than (yCb>>Log2ParMrgLevel) and where (xCb, yCb) is the top-left luma sample position of the current CU in the picture and (cbWidth, cbHeight) is the CU size. The MER size is selected at encoder side and signalled as log2_parallel_merge_level_minus2 in the sequence parameter set.

2.1.2. Merge Mode with MVD (MMVD)

In addition to merge mode, where the implicitly derived motion information is directly used for prediction samples generation of the current CU, the merge mode with motion vector differences (MMVD) is introduced in VVC. A MMVD flag is signalled right after sending a skip flag and merge flag to specify whether MMVD mode is used for a CU.

In MMVD, after a merge candidate is selected, it is further refined by the signalled MVDs information. The further information includes a merge candidate flag, an index to specify motion magnitude, and an index for indication of motion direction. In MMVD mode, one for the first two candidates in the merge list is selected to be used as MV basis. The merge candidate flag is signalled to specify which one is used.

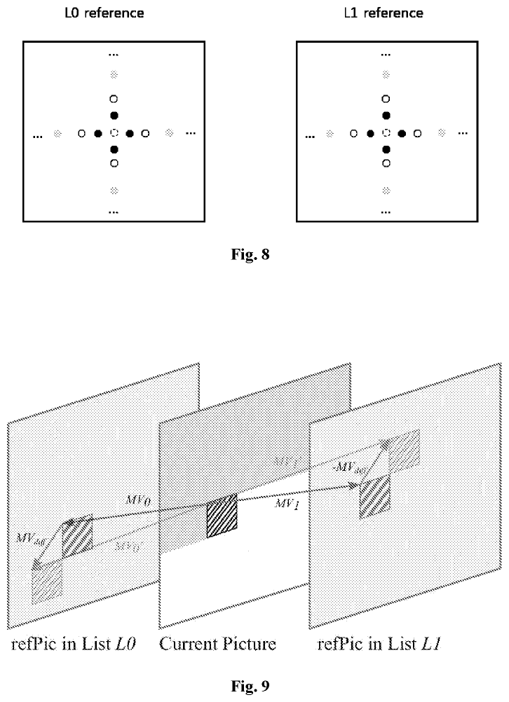

Distance index specifies motion magnitude information and indicate the pre-defined offset from the starting point. As shown in FIG. 8, an offset is added to either horizontal component or vertical component of starting MV. The relation of distance index and pre-defined offset is specified in Table 1

TABLE 1
The relation of distance index and pre-defined offset

| | Distance IDX | | | | | | | |
|---|---|---|---|---|---|---|---|---|
| | 0 | 1 | 2 | 3 | 4 | 5 | 6 | 7 |
| Offset (in unit | ¼ | ½ | 1 | 2 | 4 | 8 | 16 | 32 |
| of luma sample) | | | | | | | | |

Direction index represents the direction of the MVD relative to the starting point. The direction index can represent of the four directions as shown in Table 2. It's noted that the meaning of MVD sign could be variant according to the information of starting MVs. When the starting MVs is an un-prediction MV or bi-prediction MVs with both lists point to the same side of the current picture (i.e. POCs of two references are both larger than the POC of the current picture, or are both smaller than the POC of the current picture), the sign in Table 2 specifies the sign of MV offset added to the starting MV. When the starting MVs is bi-prediction MVs with the two MVs point to the different sides of the current picture (i.e. the POC of one reference is larger than the POC of the current picture, and the POC of the other reference is smaller than the POC of the current picture), the sign in Table 2 specifies the sign of MV offset added to the list0 MV component of starting MV and the sign for the list1 MV has opposite value.

TABLE 2
Sign of MV offset specified by direction index

| Direction IDX | 00 | 01 | 10 | 11 |
|---|---|---|---|---|
| x-axis | + | − | N/A | N/A |
| y-axis | N/A | N/A | + | − |

### 2.1.3. Decoder Side Motion Vector Refinement (DMVR)

In order to increase the accuracy of the MVs of the merge mode, a bilateral-matching based decoder side motion vector refinement is applied in VVC. In bi-prediction operation, a refined MV is searched around the initial MVs in the reference picture list L0 and reference picture list L1. The BM method calculates the distortion between the two candidate blocks in the reference picture list L0 and list L1. As illustrated in FIG. 9, the SAD between the red blocks based on each MV candidate around the initial MV is calculated. The MV candidate with the lowest SAD becomes the refined MV and used to generate the bi-predicted signal.

In VVC, the DMVR can be applied for the CUs which are coded with following modes and features:
CU level merge mode with bi-prediction MV
One reference picture is in the past and another reference picture is in the future with respect to the current picture
The distances (i.e. POC difference) from two reference pictures to the current picture are same
Both reference pictures are short-term reference pictures
CU has more than 64 luma samples
Both CU height and CU width are larger than or equal to 8 luma samples
BCW weight index indicates equal weight
WP is not enabled for the current block
CIIP mode is not used for the current block

The refined MV derived by DMVR process is used to generate the inter prediction samples and also used in temporal motion vector prediction for future pictures coding. While the original MV is used in deblocking process and also used in spatial motion vector prediction for future CU coding.

The additional features of DMVR are mentioned in the following sub-clauses.

### 2.1.3.1. Searching Scheme

In DVMR, the search points are surrounding the initial MV and the MV offset obey the MV difference mirroring rule. In other words, any points that are checked by DMVR, denoted by candidate MV pair (MV0, MV1) obey the following two equations:

$$MV {0}^{′} = MV 0 + MV\_offset \qquad ( 1 )$$

$$MV {1}^{′} = MV 1 - MV\_offset \qquad ( 2 )$$

Where MV_offset represents the refinement offset between the initial MV and the refined MV in one of the reference pictures. The refinement search range is two integer luma samples from the initial MV. The searching includes the integer sample offset search stage and fractional sample refinement stage.

25 points full search is applied for integer sample offset searching. The SAD of the initial MV pair is first calculated. If the SAD of the initial MV pair is smaller than a threshold, the integer sample stage of DMVR is terminated. Otherwise SADs of the remaining 24 points are calculated and checked in raster scanning order. The point with the smallest SAD is selected as the output of integer sample offset searching stage. To reduce the penalty of the uncertainty of DMVR refinement, it is proposed to favor the original MV during the DMVR process. The SAD between the reference blocks referred by the initial MV candidates is decreased by ¼ of the SAD value.

The integer sample search is followed by fractional sample refinement. To save the calculational complexity, the fractional sample refinement is derived by using parametric error surface equation, instead of additional search with SAD comparison. The fractional sample refinement is conditionally invoked based on the output of the integer sample search stage. When the integer sample search stage is terminated with center having the smallest SAD in either the first iteration or the second iteration search, the fractional sample refinement is further applied.

In parametric error surface based sub-pixel offsets estimation, the center position cost and the costs at four neighboring positions from the center are used to fit a 2-D parabolic error surface equation of the following form

$$E ( x , y ) = {A ( x - {x}_{min} )}^{2} + {B ( y - {y}_{min} )}^{2} + C \qquad ( 3 )$$

where (xₘᵢₙ, yₘᵢₙ) corresponds to the fractional position with the least cost and C corresponds to the minimum cost value. By solving the above equations by using the cost value of the five search points, the (xₘᵢₙ, yₘᵢₙ) is computed as:

$${x}_{min} = ( E ( - 1 , 0 ) - E ( 1 , 0 ) ) / ( 2 ( E ( - 1 , 0 ) + E ( 1 , 0 ) - 2 E ( 0 , 0 ) ) ) \qquad ( 4 )$$

$${y}_{min} = ( E ( 0 , - 1 ) - E ( 0 , 1 ) ) / ( 2 ( ( E ( 0 , - 1 ) + E ( 0 , 1 ) - 2 E ( 0 , 0 ) ) ) \qquad ( 5 )$$

The value of xₘᵢₙ and yₘᵢₙ are automatically constrained to be between −8 and 8 since all cost values are positive and the smallest value is E(0,0). This corresponds to half peal offset with 1/16th-pel MV accuracy in VVC. The computed fractional (xₘᵢₙ, yₘᵢₙ) are added to the integer distance refinement MV to get the sub-pixel accurate refinement delta MV.

### 2.1.3.2. Bilinear-Interpolation and Sample Padding

In VVC, the resolution of the MVs is 1/16 luma samples. The samples at the fractional position are interpolated using a 8-tap interpolation filter. In DMVR, the search points are surrounding the initial fractional-pel MV with integer sample offset, therefore the samples of those fractional position need to be interpolated for DMVR search process. To reduce the calculation complexity, the bi-linear interpolation filter is used to generate the fractional samples for the searching process in DMVR. Another important effect is that by using bi-linear filter is that with 2-sample search range, the DVMR does not access more reference samples compared to the normal motion compensation process. After the refined MV is attained with DMVR search process, the normal 8-tap interpolation filter is applied to generate the final prediction. In order to not access more reference samples to normal MC process, the samples, which is not needed for the interpolation process based on the original MV but is needed for the interpolation process based on the refined MV, will be padded from those available samples.

### 2.1.3.3. Maximum DMVR Processing Unit

When the width and/or height of a CU are larger than 16 luma samples, it will be further split into subblocks with width and/or height equal to 16 luma samples. The maximum unit size for DMVR searching process is limit to 16×16.

### 2.1.4. Geometric Partitioning Mode (GPM) for Inter Prediction

In VVC, a geometric partitioning mode is supported for inter prediction. The geometric partitioning mode is signalled using a CU-level flag as one kind of merge mode, with other merge modes including the regular merge mode, the MMVD mode, the CIIP mode and the subblock merge mode. In total 64 partitions are supported by geometric partitioning mode for each possible CU size w×h=2^{m}×2ⁿ with m, n∈{3 . . . 6} excluding 8×64 and 64×8.

When this mode is used, a CU is split into two parts by a geometrically located straight line as shown in FIG. 10. The location of the splitting line is mathematically derived from the angle and offset parameters of a specific partition. Each part of a geometric partition in the CU is inter-predicted using its own motion; only uni-prediction is allowed for each partition, that is, each part has one motion vector and one reference index. The uni-prediction motion constraint is applied to ensure that same as the conventional bi-prediction, only two motion compensated prediction are needed for each CU. The uni-prediction motion for each partition is derived using the process described in 3.4.1.

If geometric partitioning mode is used for the current CU, then a geometric partition index indicating the partition mode of the geometric partition (angle and offset), and two merge indices (one for each partition) are further signalled. The number of maximum GPM candidate size is signalled explicitly in SPS and specifies syntax binarization for GPM merge indices. After predicting each of part of the geometric partition, the sample values along the geometric partition edge are adjusted using a blending processing with adaptive weights as in 3.4.2. This is the prediction signal for the whole CU, and transform and quantization process will be applied to the whole CU as in other prediction modes. Finally, the motion field of a CU predicted using the geometric partition modes is stored as in 3.4.3.

### 2.1.4.1. Uni-Prediction Candidate List Construction

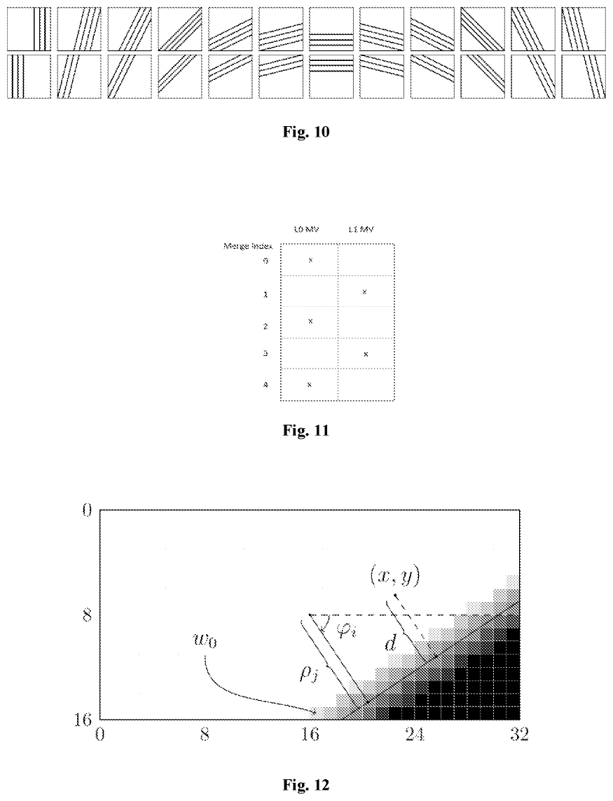

The uni-prediction candidate list is derived directly from the merge candidate list constructed according to the extended merge prediction process in 3.4.1. Denote n as the index of the uni-prediction motion in the geometric uni-prediction candidate list. The LX motion vector of the n-th extended merge candidate, with X equal to the parity of n, is used as the n-th uni-prediction motion vector for geometric partitioning mode. These motion vectors are marked with “x” in FIG. 11. In case a corresponding LX motion vector of the n-the extended merge candidate does not exist, the L(1−X) motion vector of the same candidate is used instead as the uni-prediction motion vector for geometric partitioning mode.

### 2.1.4.2. Blending Along the Geometric Partitioning Edge

After predicting each part of a geometric partition using its own motion, blending is applied to the two prediction signals to derive samples around geometric partition edge. The blending weight for each position of the CU are derived based on the distance between individual position and the partition edge.

The distance for a position (x, y) to the partition edge are derived as:

$$d ( x , y ) = ( 2 x + 1 - w ) cos ( {φ}_{i} ) + ( 2 y + 1 - h ) sin ( {φ}_{i} ) - {ρ}_{j} \qquad ( 6 )$$

$${ρ}_{j} = {ρ}_{x , j} cos ( {φ}_{i} ) + {ρ}_{y , i} sin ( {φ}_{i} ) \qquad ( 7 )$$

$${ρ}_{x , j} = \{ \begin{matrix}0 & i \% 16 = 8 or ( i \% 16 \neq 0 and h \geq w ) \\ \pm ( j \times w ) ≫ 2 & otherwise\end{matrix} \qquad ( 8 )$$

$${ρ}_{y , i} = \{ \begin{matrix}\pm ( j \times h ) ≫ 2 & i \% 16 = 8 or ( i \% 16 \neq 0 and h \geq w ) \\ 0 & otherwise\end{matrix} \qquad ( 9 )$$

where i,j are the indices for angle and offset of a geometric partition, which depend on the signaled geometric partition index. The sign of ρ_{x,j} and ρ_{y,j} depend on angle index i.

The weights for each part of a geometric partition are derived as following:

$$wIdxL ( x , y ) = partIdx ? 32 + d ( x , y ) : 32 - d ( x , y ) \qquad ( 10 )$$

$${w}_{0} ( x , y ) = \frac{Clip 3 ( 0 , 8 , ( wIdxL ( x , y ) + 4 ) ≫ 3 )}{8} \qquad ( 11 )$$

$${w}_{1} ( x , y ) = 1 - {w}_{0} ( x , y ) \qquad ( 12 )$$

The partIdx depends on the angle index i. One example of weigh w₀ is illustrated in FIG. 12.

### 2.1.4.3. Motion Field Storage for Geometric Partitioning Mode

Mv1 from the first part of the geometric partition, Mv2 from the second part of the geometric partition and a combined Mv of Mv1 and Mv2 are stored in the motion filed of a geometric partitioning mode coded CU.

The stored motion vector type for each individual position in the motion filed are determined as:

$$sType = abs ( motionIdx ) < 32 ? 2 : ( motionIdx \leq 0 ? ( 1 - partIdx ) : partIdx ) \qquad ( 13 )$$

where motionIdx is equal to d(4x+2, 4y+2). The partIdx depends on the angle index i.

If sType is equal to 0 or 1, Mv0 or Mv1 are stored in the corresponding motion field, otherwise if sType is equal to 2, a combined My from Mv0 and Mv2 are stored. The combined My are generated using the following process:
1) If Mv1 and Mv2 are from different reference picture lists (one from L0 and the other from L1), then Mv1 and Mv2 are simply combined to form the bi-prediction motion vectors.
2) Otherwise, if Mv1 and Mv2 are from the same list, only uni-prediction motion Mv2 is stored.
   2.2. Geometric Prediction Mode with Motion Vector Differences (GMVD) in JVET-R0357

In the contribution JVET-R0357, Geometric prediction mode with Motion Vector Difference (GMVD) is proposed. With GMVD, each geometric partition in GPM can decide to use GMVD or not. If GMVD is chosen for a geometric region, the MV of the region is calculated as a sum of the MV of a merge candidate and an MVD. All other processing is kept the same as in GPM.

With GMVD, an MVD is signaled as a pair of direction and distance, following the current design of MMVD. That is, there are eight candidate distances (¼-pel, ½-pel, 1-pel, 2-pel, 4-pel, 8-pel, 16-pel, 32-pel), and four candidate directions (toward-left, toward-right, toward-above, and toward-below). In addition, when pic_fpel_mmvd_enabled flag is equal to 1, the MVD in GMVD is also left shifted by 2 as in MMVD.

### 2.3. GPM Merge List Generation in PCT/CN2021/086212

The detailed inventions below should be considered as examples to explain general concepts. These inventions should not be interpreted in a narrow way. Furthermore, these inventions can be combined in any manner.

The term ‘GPM’ may represent a coding method that split one block into two or more sub-regions wherein at least one sub-region is non-rectangular, or non-square, or it couldn't be generated by any of existing partitioning structure (e.g., QT/BT/TT) which splits one block into multiple rectangular sub-regions. In one example, for the GPM coded blocks, one or more weighting masks are derived for a coding block based on how the sub-regions are split, and the final prediction signal of the coding block is generated by a weighted-sum of two or more auxiliary prediction signals associated with the sub-regions.

The term ‘GPM’ may indicate the geometric merge mode (GEO), and/or geometric partition mode (GPM), and/or wedge prediction mode, and/or triangular prediction mode (TPM), and/or a GPM block with motion vector difference (GMVD), and/or a GPM block with motion refinement, and/or any variant based on GPM.

The term ‘block’ may represent a coding block (CB), a CU, a PU, a TU, a PB, a TB.

The phrase “normal/regular merge candidate” may represent the merge candidates generated by the extended merge prediction process (as illustrated in section 3.1). It may also represent any other advanced merge candidates except GEO merge candidates and subblock based merge candidates.

Note that a part/partition of a GPM block means a part of a geometric partition in the CU, e.g., the two parts of a GPM block in FIG. 10 are split by a geometrically located straight line. Each part of a geometric partition in the CU is inter-predicted using its own motion, but the transform is performed for the whole CU rather than each part/partition of a GPM block.

It should also be noticed that GPM/GMVD applied to other modes (e.g., AMVP mode) may also use the following methods wherein the merge candidate list may be replaced by an AMVP candidate list.
1. It is proposed that the GPM/GMVD candidate index of a block being equal to K may be corresponding to motion information derived from a regular merge candidate with index being equal to M in the regular merge candidate list wherein K is unequal to M, and the derived motion information is used for coding the block.
   1) In one example, M is greater than K.
   2) Whether to use the regular merge candidate with index being equal to K or M may depend on the decoded information and/or the candidates in the regular merge candidate list.
2. Pruning process may be applied during the GPM/GMVD merge list construction wherein motion candidates may be derived using the parity of candidate indices.
   a) In one example, GPM/GMVD merge list is constructed, then the GPM/GMVD merge list is modified by pruning.
   b) In one example, pruning is applied when inserting a candidate into the GPM/GMVD merge list, during the list construction process.
   c) For example, full pruning may be applied.
   d) For example, partial pruning may be applied.
   e) For example, whether to insert a candidate to a GPM/GMVD merge list, may be dependent on whether it has similar/different motion data as compared with one or more candidates in the list.
   f) For example, whether to insert a candidate to a GPM/GMVD merge list, may be dependent on how similar/different between this candidate and one or more candidates in the list.
   g) For example, the above comparison may be applied between the candidate and all available candidates in the GPM/GMVD merge list.
   h) For example, the above comparison may be applied between the candidate and one candidate in the GPM/GMVD merge list, wherein the one candidate may be in a predefined position.
   i) For example, the above comparison may be conducted by checking the motion data difference such as prediction direction (L0, L1), motion vectors, POC value, and/or any other inter-prediction mode (such as affine, BCW, LIC) etc.
   j) For example, the above comparison may be conducted based on a rule that whether the motion difference is greater than or smaller than a threshold.
   k) For example, the above comparison may be conducted based on a rule that whether the motion of the two are identical.
   l) In above examples, the GMVD candidate is representing the motion information derived from the associated GPM candidate plus the selected MVD.
3. If the number of valid GPM merge candidates is less than a threshold, at least one additional GPM merge candidate may be generated to fill in the GPM merge candidate list.
   1) For example, the value of the threshold may be obtained by a syntax element.
      a) For example, the syntax element may be a value specifying the maximum GPM merge candidates in the GPM merge candidate list or the maximum number of regular merge candidates.
   2) For example, one or more GPM merge candidates may be generated based on the existing GPM merge candidates in the GPM merge candidate list.
      a) For example, the L0 motion of the first X (such as X=2) L0 predicted GPM merge candidates in the GPM merge list may be averaged and inserted to the GPM merge list as an additional GPM merge candidate.
      b) For example, the L1 motion of the first X (such as X=2) L1 predicted GPM merge candidates in the GPM merge list may be averaged and inserted to the GPM merge list as an additional GPM merge candidate.
   3) For example, one or more GPM merge candidate may be generated through a history based GPM merge candidate table.
      a) For example, the history based GPM merge candidate table is maintained with a length of K (such as K is a constant) GPM motions.
      b) For example, the history based GPM merge candidate table contains motion data of L (such as L is a constant) previous coded GPM blocks.
         a. For example, both the two motion vectors of the two parts of a GPM coded block are inserted to the history based GPM merge candidate table.
         b. For example, one of the two motion vectors of the two parts of a GPM coded block are inserted to the history based GPM merge candidate table.
      c) For example, at most M candidates in the history based GPM merge candidate table can be inserted to the GPM merge list.
   4) For example, one or more uni-prediction GPM merge candidates may be generated based on the regular merge candidate and its position in the regular merge candidate list.
      a) For example, if the parity of a regular merge candidate is an odd number, its L0 motion data may be extracted to construct the GPM merge candidate list.
      b) For example, if the parity of a regular merge candidate is an even number, its L1 motion data may be extracted to construct the GPM merge candidate list.
   5) For example, one or more uni-prediction zero motion vectors may be inserted to the GPM merge list.
      a) For example, L0 predicted zero motion vectors may be inserted.
      b) For example, L1 predicted zero motion vectors may be inserted.
      c) For example, how many zero motion vectors is inserted to the list may be dependent on the number of active reference pictures in L0/L1 direction.
         a. For example, the zero motion vectors may be inserted with an increasing order of a reference index equal to a value from 0 to the number of active reference pictures in L0/L1 direction.
         d) Alternatively, furthermore, the maximum number of GPM candidates may be larger than that for regular merge candidate list.
4. One or multiple HMVP tables may be maintained for proceeding blocks coded with GPM/GMVD modes.
   1) In one example, the motion information of a GPM/GMVD coded blocks (e.g., a pair of motion vectors as well the associated prediction lists/reference picture information) may be used to update the HMVP tables.
   2) In one example, those HMVP tables used for GPM/GMVD modes are maintained independently from those used for non-GPM/GMVD modes.
5. Motion information from non-adjacent spatial blocks may be used to derive the motion information of a GPM/GMVD coded block.
   1) In one example, non-adjacent spatial merge candidates may be used to build the GPM merge candidate list.
   2) For example, the non-adjacent spatial merge candidates may be generated based on the motion data for neighbor blocks which are not directly adjacent to the current block.
6. Denote a GPM candidate index of a block being equal to K. Even the corresponding LX motion vector of the K-th merge candidate exists (X equal to the parity of K), the L(1−X) motion vector of the K-th candidate could still be used to derive the motion information of the block.
   1) In one example, whether to use LX or L(1−X) may depend on the motion information of merge candidates in the regular/GPM merge candidate list.
      a) In one example, if the LX motion information is identical to one or more GPM candidates with indices smaller than K, then L(1−X) motion information may be used.
   2) Whether to insert L0 motion or L1 motion to construct the uni-prediction GPM merge list, may be dependent on the accumulated value of the prediction directions from the already inserted GPM merge candidates in the GPM merge list. Suppose X denotes the number of L0 prediction GPM merge candidates precede the current GPM candidate to be inserted, and Y denotes the number of L1 prediction merge candidates precede the current GPM candidate to be inserted.
      a) For example, when X minus Y is no smaller than a threshold (such as 0 or 1 or 2), L1 motion may be extracted from a bi-prediction normal merge candidate and inserted to be as a GPM merge candidate.
         a. Additionally, in such case, L1 motion of a L1 prediction normal merge candidate may be directly inserted to be as a GPM merge candidate.
         b. Additionally, in such case, a L0 prediction normal merge candidate may be projected to L1 and inserted to be as a GPM merge candidate.
      b) For example, when X minus Y is no greater than a threshold (such as 0 or −1 or −2), L0 motion may be extracted from a bi-prediction normal merge candidate and inserted to be as a GPM merge candidate.
         a. Additionally, in such case, L0 motion of a L0 prediction normal merge candidate may be directly inserted to be as a GPM merge candidate.
         b. Additionally, in such case, a L1 prediction normal merge candidate may be projected to L0 and inserted to be as a GPM merge candidate.
7. In one example, one bi-prediction normal merge candidate may generate two uni-prediction GPM merge candidates, and both added to GPM/GMVD candidate list.
   1) For example, the L0 motion of the bi-prediction normal merge candidate may be used to form a uni-prediction GPM merge candidate, while the L1 motion of the same normal merge candidate is used to form another uni-prediction GPM merge candidate.
8. In one example, both uni-prediction GPM merge candidates and bi-prediction GPM merge candidates may be allowed.
   1) For example, it may be allowed that one part of a GPM block is coded from uni-prediction, while the other part of the GPM block is coded from bi-prediction.
   2) For example, both the two parts of a GPM block are coded from bi-prediction.
   3) For example, when the two parts of a GPM block are coded from uni-prediction, it may be required that one is from L0 prediction, and the other is from L1 prediction.
9. In one example, the regular MMVD based motion vector may be used to build the GPM merge candidate list.
   1) For example, L0 or L1 (but not both) motion of the regular MMVD based motion vector may be inserted to the GPM merge candidate list.
   2) For example, both L0 and L1 motion of the regular MMVD based motion vector may be inserted to the GPM merge candidate list.
   3) For example, the GPM related syntax elements may be signalled in case of regular MMVD is used to the video unit.
10. In one example, the GPM merge candidates in the GPM list may be reordered based on a rule.
   1) For example, the rule may be defined as sorting a template cost from small to big values.
   2) For example, the template cost may be based on the sum of sample difference between left and/or above neighboring reconstructed samples of the current block and the corresponding neighbors of the reference block.
11. In one example, a GMVD candidate may be compared with a GMVD candidate or a GPM candidate.
   1) For example, if the final motion information (after reconstructing the MV from the base MV and MV difference) of a first GMVD candidate is the same or similar to that of a second GMVD or GPM candidate, then the first GMVD candidate is pruned, i.e. it is removed from the possible candidate that can be represented.
   2) For example, if the final motion information (after reconstructing the MV from the base MV and MV difference) of a first GMVD candidate is the same or similar to that of a second GMVD or GPM candidate, then the first GMVD candidate is modified.
      a) For example, the final MV may be added by a shifting value.
      b) For example, the first GMVD candidate may be modified more than once, until it is not same or similar to a second GMVD or GPM candidate.
   3) The comparison method may be defined in bullet 2.

### 2.4. GMVD Merge Index Signalling in PCT/CN2021/086307

The detailed inventions below should be considered as examples to explain general concepts. These inventions should not be interpreted in a narrow way. Furthermore, these inventions can be combined in any manner.

The term ‘GPM’ may represent a coding method that split one block into two or more partition/sub-regions wherein at least one partition/sub-region is non-rectangular, or non-square, or it couldn't be generated by any of existing partitioning structure (e.g., QT/BT/TT) which splits one block into multiple rectangular sub-regions. In one example, for the GPM coded blocks, one or more weighting masks are derived for a coding block based on how the sub-regions are split, and the final prediction signal of the coding block is generated by a weighted-sum of two or more auxiliary prediction signals associated with the sub-regions.

The term ‘GPM’ may indicate the geometric merge mode (GEO), and/or geometric partition mode (GPM), and/or wedge prediction mode, and/or triangular prediction mode (TPM), and/or a GPM block with motion vector difference (GMVD), and/or a GPM block with motion refinement, and/or any variant based on GPM.

The term ‘block’ may represent a coding block (CB), a CU, a PU, a TU, a PB, a TB.

The phrase “normal/regular merge candidate” may represent the merge candidates generated by the extended merge prediction process (as illustrated in section 3.1). It may also represent any other advanced merge candidates except GEO merge candidates and subblock based merge candidates.

Note that a part/partition of a GPM/GMVD block means a part of a geometric partition in the CU, e.g., the two parts of a GPM block in FIG. 10 are split by a geometrically located straight line. Each part of a geometric partition in the CU is inter-predicted using its own motion, but the transform is performed for the whole CU rather than each part/partition of a GPM block.

It is noticed that we use “one set of motion information associated with one part” of a GPM coded block in the following descriptions, even though the motion information of one part may be also applied to the other part due to weighting masks. It could be interpreted that multiple (denoted by K) motion candidate indices for a GPM coded blocks with K parts.

It should also be noticed that GPM/GMVD applied to other modes (e.g., AMVP mode) may also use the following methods wherein the merge candidate list may be replaced by an AMVP candidate list.
1. In one example, the motion information of multiple parts of a video unit may be derived from the same merge candidate.
   a) In one example, the two pieces of motion information of two parts may be the same.
      a. In one example, list X (e.g., X=0 or 1) motion information is used for the two parts.
   b) In one example, the two pieces of motion information of two parts may be derived from the same merge candidate, but the two pieces of motion information may be different.
      a. In one example, list X motion information is used for one of the two parts, and list Y motion information is used for the other part.
   c) In one example, the video unit may be partitioned by a GPM mode without MVD.
   d) In one example, the video unit may be partitioned by a GPM mode with MVD (e.g., GMVD).
   e) In one example, the merge candidate may be a GPM/GMVD merge candidate, or a normal merge candidate, or other extended/advanced merge candidate.
2. In one example, whether the motion information of multiple parts of a video unit is derived from the same merge candidate may be dependent on whether a non-zero motion vector difference is applied to a GPM block.
   a. For example, only if GPM with non-zero motion vector difference (e.g., GMVD) is used for a video unit (e.g., video block), the motion information of multiple parts of a video unit is allowed to be derived from the same merge candidate.
   b. For example, in case that a video block is coded by GPM without motion vector difference, the motion information of multiple parts of a video unit is not allowed to be derived from the same merge candidate.
   c. For example, an indication of whether GMVD is used for a video block may be signalled before the GPM merge candidate index.
      a. Alternatively, furthermore, how to signal motion candidate indices (e.g., the GPM merge candidate indices) may dependent on the usage of GMVD.
3. In one example, if the two pieces of motion information of two parts of a GPM block are derived from the same merge candidate, one or more of the following rules may be applied:
   a. For example, at least one part of the video block is coded with GPM with MVD.
   b. For example, if both parts are coded with GPM with MVD, then the MVD of the two parts are not the same.
   c. For example, if both parts are coded with GPM with MVD, then the difference (or absolute difference) between two MVDs of the two parts shall be less than (or beyond) a threshold.
      b. For example, adaptive threshold values may be used.
         a) For example, the adaptive threshold depends on the size of the current video unit.
         b) For example, the adaptive threshold depends on the number of pixels/samples in the current video unit.
      c. For example, fixed threshold value may be used.
   d. For example, if one of the two parts is coded with GPM with MVD, and the other part is coded with GPM without MVD, then one and only one of the following cases is allowed:
      d. Part-0 is coded with GPM without MVD, Part-1 is coded with GPM with MVD.
      e. Part-0 is coded with GPM with MVD, Part-1 is coded with GPM without MVD.
4. In one example, a syntax element (e.g., a flag) may be signalled for a video unit (e.g., a video block) specifying whether the motion information of multiple parts of a video unit is derived from the same merge candidate.
   a. For example, the video unit may be coded with GPM without MVD.
   b. For example, the video unit may be coded with GPM with MVD (e.g., GMVD).
   c. For example, the syntax element may be conditionally signaled.
      f. It may be based on whether the current video unit is coded with GMVD.
      g. It may be based on whether the current video unit is coded with GPM without MVD.
      h. It may be based on whether there is at least one part of the video block is coded with motion vector difference (e.g., GMVD, MMVD, MMVD).
         a) For example, when part-A (e.g., A=0) uses GMVD and part-B (e.g., B=1) used GPM without MVD, the syntax element is not signalled but inferred to be equal to a value specifying the two pieces of motion information of two parts of the current video unit are derived from difference merge candidates.
      i. It may be based on whether the motion vector differences of all parts are the same.
      j. It may be based on whether the difference or absolute difference between the two motion vector differences of the two part is within/beyond a threshold.
         a) For example, adaptive threshold values may be used.
         i. For example, the adaptive threshold depends on the size of the current video unit.
         ii. For example, the adaptive threshold depends on the number of pixels/samples in the current video unit.
         b) For example, fixed threshold value may be used.
   d. For example, the syntax element is coded with context based arithmetic coding.
   e. Alternatively, furthermore, how many candidate indices to be coded may depend on the syntax element.
5. It is proposed that at least one of motion candidate indices for a GPM coded block is not present in a bitstream.
   a. In one example, a first GPM merge index is signalled for a video block, but the second GPM merge index may be not signalled.
   b. For example, the second GPM merge index is not signaled in case it is informed that the two pieces of motion information of two parts of the current video unit are derived from the same merge candidate.
   c. For example, there may be only one GPM merge index signaled for the whole video block.
   d. For example, how to derive the other GPM merge index may be dependent on whether all parts of the current video unit use same merge candidate.
   e. For example, when the other GPM merge index is not present, the other GPM merge index for the other part may be derived from the signalled GPM merge index.
   f. For example, when the other GPM merge index is not present, it is inferred to be equal to the first signalled GPM merge index.
6. In one example, the signalling of whether a specified part of a GPM block is coded with MVD may be dependent on whether the motion information of multiple parts of a video unit is derived from the same merge candidate.
   a. For example, a syntax element A (e.g., a flag) may be signalled specifying whether a specified part of a GPM block is coded with MVD (e.g., a specified part is GMVD coded).
   b. Additionally, the syntax element A may be conditionally signalled based on whether the motion information of multiple parts of a video unit is derived from the same merge candidate.
   c. For example, when whether the motion information of all parts of a video unit is derived from the same merge candidate, the syntax element A for a certain part (e.g., the second part) may be not signalled but inferred to be equal to a value specifying this certain part of a GPM block is coded with MVD.
7. In one example, the signaled GPM merge candidates index (e.g., merge_gpm_idx0, merge_gpm_idx1) for all parts (e.g., part0 and part1 of a GPM block) may be used to calculate the motion vectors of the merging candidate X at position Px in the merging candidate list mergeCandList (X=mergeCandList[Px]), where Px indicates the signaled gpm merge candidates index (e.g., merge_gpm_idx0, merge_gpm_idx1).
   a. For example, whether the above claim is applied may be always applied for a GPM coded block without MVD.
   b. For example, whether the above claim is applied may be always applied for a GMVD coded block.
   c. For example, whether the above claim is applied to a GPM or GMVD may be dependent on a condition (e.g., a syntax element).
8. In one example, the binarization process of GPM merge candidate index coding may be the same for all candidates to be coded (e.g., corresponding to multiple parts).
   a. For example, during the binarization process, the value of the input parameter (e.g., cMax) for part-0 gpm merge candidate index and the value of the input parameter (e.g., cMax) for part-1 gpm merge candidate index are same (e.g., cMax=MaxNumGpmMergeCand−1, wherein MaxNumGpmMergeCand denotes the maximum allowed number of GPM merge candidates).
9. In one example, even when the maximum number of normal merge candidate is equal to one, the GPM/GMVD may be applied as well.
   a. For example, in such case, the GPM enabled/disabled flag may be still signaled at SPS level.
   b. For example, in such case, the GPM merge candidate index of a GPM part may be not signalled but inferred to be equal to the GPM merge candidate index of the other GPM part.
   c. For example, in such case, the maximum number of GPM merge candidates may be not signalled but inferred to a predefined number (such as one or two).
   d. For example, the maximum number of GPM merge candidate may be allowed to be equal to 1, no matter the number of the maximum number of normal merge candidates.
   e. For example, the maximum number of GPM merge candidate may be allowed to be greater than the maximum number of normal merge candidates.
   f. For example, whether GPM is enabled or not may be not conditioned on whether the maximum number of normal merge candidates is greater than one or two.
      k. For example, the indication of maximum GPM merge candidate may be not conditioned on whether the maximum number of normal merge candidates is greater than one or two.
      l. For example, the GPM merge candidate index may be not conditioned on whether the maximum number of normal merge candidates is greater than one or two.
      m. For example, i) whether GPM is enabled or not, and/or ii) the indication of maximum GPM merge candidate, and/or iii) the GPM merge candidate index, may be conditioned on whether the maximum number of normal merge candidates is greater than zero.
      n. For example, i) whether GPM is enabled or not, and/or ii) the indication of maximum GPM merge candidate, and/or iii) the GPM merge candidate index, may be signalled without conditions.
10. It is proposed that the motion information derived from a first merge candidate of a part in a GPM and/or GMVD coded block may be modified if it is the same to the motion information derived from a second merge candidate.
   a. For example, the MV may be added by a shifting motion vector such as (dx, dy).
   b. For example, the reference index may be changed.
   c. The modification process may be invoked iteratively until the motion information derived from a first merge candidate is not the same to to the motion information derived from any merge candidate that is before the first merge candidate.
11. Embodiments #1 (on top of JVET-T2001-v2)

Below are some example embodiments for some of the invention aspects summarized above in Section 5, which can be applied to the VVC specification. The changed texts are based on the latest VVC text in JVET-Q2001-vE. Most relevant parts that have been added or modified are highlighted in underlined, and some ofthe deleted parts are

[symbol]

### The Merge Data Syntax Table is Changed as Follows:

| | Descriptor |
|---|---|
| merge_data( x0, y0, cbWidth, cbHeight, chType ) { | |
| ... | |
| if( sps_ciip_enabled_flag && sps_gpm_enabled_flag && | |
| sh_slice_type = = B && | |
| cu_skip_flag[ x0 ][ y0 ] = = 0 && cbWidth >= 8 && | |
| cbHeight >= 8 && | |
| cbWidth < ( 8 * cbHeight ) && cbHeight < ( 8 * cbWidth ) && | |
| cbWidth < 128 && cbHeight < 128 ) | |
| ciip_{—}flag[ x0 ][ y0 ] | ae(v) |
| if( ciip_flag[ x0 ][ y0 ] && MaxNumMergeCand > 1 ) | |
| merge_{—}idx[ x0 ][ y0 ] | ae(v) |
| if( !ciip_flag[ x0 ][ y0 ] ) { | |
| merge_{—}gpm_{—}partition_{—}idx[ x0 ][ y0 ] | ae(v) |
| gmvd_{—}flag[ x0 ][ y0 ] | ae(v) |
| if(gmvd_flag) | |
| both_parts_same_candidate_flag[ x0 ][ y0 ] | ae(v) |
| merge_{—}gpm_{—}idx0[ x0 ][ y0 ] | ae(v) |
| if( MaxNumGpmMergeCand > 2 && !both_parts_same candidate_flag[ x0 ][ y0 ] ) | |
| merge_{—}gpm_{—}idx1[ x0 ][ y0 ] | ae(v) |
| if(gmvd_flag) { | |
| for(partIdx=0; partIdx<2; partIdx++ ) { | |
| if(partIdx == 0 \|\| (gmvd_part_flag[x0][y0][0] | |
| && !both_parts_same candidate_flag[ x0 ][ y0 ] )) | |
| gmvd_part_flag[x0][y0][partIdx] | ae(v) |
| if(gmvd_part_flag[x0][y0][partIdx]) { | |
| gmvd_distance_idx[x0][y0][partIdx] | ae(v) |
| gmvd_direction_idx[x0][y0][partIdx] | ae(v) |
| } | |
| } | |
| } | |
| } | |
| } | |
| } | |
| } | |
| } | |

### The Merge Data Semantics are Changed as Follows:

. . .

mmvd_distance_idx [x0][y0] specifies the index used to derive MmvdDistance [x0][y0] as specified in Table 17. The array indices x0, y0 specify the location (x0, y0) of the top-left luma sample of the considered coding block relative to the top-left luma sample of the picture.

TABLE 17
Specification of MmvdDistance[ x0 ][ y0 ] based on mmvd_distance_idx[ x0 ][ y0 ]

| mmvd_distance_idx[ x0 ][ y0 ] | | |
|---|---|---|
| or | MmvdDistance[ x0 ][ y0 ] | |
| gmvd_distance_idx[ x0 ][ y0 ][ | or GmvdDistance[ x0 ]] y0 ][ partIdx ] | |
| partIdx ] | ph_mmvd_fullpel_only_flag = = 0 | ph_mmvd_fullpel_only_flag = = 1 |
| 0 | 1 | 4 |
| 1 | 2 | 8 |
| 2 | 4 | 16 |
| 3 | 8 | 32 |
| 4 | 16 | 64 |
| 5 | 32 | 128 |
| 6 | 64 | 256 |
| 7 | 128 | 512 |

mmvd_direction_idx[x0][y0] specifies index used to derive MmvdSign[x0][y0] as specified in Table 18. The array indices x0, y0 specify the location (x0, y0) of the top-left luma sample of the considered coding block relative to the top-left luma sample of the picture.

TABLE 18
Specification of MmvdSign [ x0 ][ y0 ] based on mmvd_direction_idx[ x0 ][ y0 ]

| mmvd_direction_idx[ x0 ][ y0 ] | MmvdSign[ x0 ][ y0 ][ 0 ] | MmvdSign[ x0 ][ y0 ][ 1 ] |
|---|---|---|
| or | or | or |
| gmvd_direction_idx[ x0 ][ y0 ] | GmvdSign[ x0 ][ y0 ][0] | GmvdSign[ x0 ][ y0 ][1] |
| 0 | +1 | 0 |
| 1 | −1 | 0 |
| 2 | 0 | +1 |
| 3 | 0 | −1 |

Both components of the merge plus MVD offset MmvdOffset[x0][y0] are derived as follows:

$$MmvdOffset [ x 0 ] [ y 0 ] [ 0 ] = ( MmvdDistance [ x 0 ] [ y 0 ] ≪ 2 ) * MmvdSign [ x 0 ] [ y 0 ] [ 0 ] \qquad ( 181 )$$

$$MmvdOffset [ x 0 ] [ y 0 ] [ 1 ] = ( MmvdDistance [ x 0 ] [ y 0 ] ≪ 2 ) * MmvdSign [ x 0 ] [ y 0 ] [ 1 ] \qquad ( 182 )$$

[symbol]

[symbol]

[symbol]

[symbol]

[symbol]

[symbol]

[symbol]

[symbol]

[symbol]

[symbol]

[symbol]

[symbol]

[symbol]

[symbol]

[symbol]

[symbol]

[symbol]

[symbol]

[symbol]

[symbol]

[symbol]

[symbol]

[symbol]

[symbol]

gmvd_flag[x0][v0] specifies whether the geometric prediction with motion vector difference is applied for the current coding unit. The array indices x0, v0 specify the location (x0, v0) of the top-left luma sample of the considered coding block relative to the top-left luma sample of the picture.

both parts same candidate flag[x0][v0] specifies whether the two parts of the current geometric partitioning CU are using the same merging candidate index of the geometric partitioning based motion compensation candidate list.

When both parts same candidate flag[x0][y0] is not present, it is inferred to be equal to 0.

merge_gpm_idx0[x0][y0] specifies the first merging candidate index of the geometric partitioning based motion compensation candidate list where x0, y0 specify the location (x0, y0) of the top-left luma sample of the considered coding block relative to the top-left luma sample of the picture.

When merge_gpm_idx0[x0][v0] is not present, it is inferred to be equal to 0.

merge_gpm_idx1[x0][y0] specifies the second merging candidate index of the geometric partitioning based motion compensation candidate list where x0, y0 specify the location (x0, y0) of the top-left luma sample of the considered coding block relative to the top-left luma sample of the picture.

When merge_gpm_idx1[x0][y0] is not present, it is inferred to be equal to merge_gpm_idx0[x0][v0].

gmvd_part_flag[x0][v0][partIdx] with partIdx equal to 0 or 1 specifies whether the geometric prediction with motion vector difference is applied for the partition with index equal to partIdx in the current coding unit. The array indices x0, y0 specify the location (x0, y0) of the top-left luma sample of the considered coding block relative to the top-left luma sample of the picture. When gmvd_part_flag[x0][v0][partIdx] is not present, it is inferred to be equal to 1 if gmvd_flag[x0][y0] is equal to 1 and partIdx is equal to 1. Otherwise, it is inferred to be equal to 0.

gmvd_distance_idx[x0][y0][partIdx] with partIdx equal to 0 or 1 specifies the index used to derive GmvdDistance[x0][y0] [partIdx] as specified in Table 17. The array indices x0, y0 specify the location (x0, y0) of the top-left luma sample of the considered coding block relative to the top-left luma sample of the picture.

gmvd_direction_idx[x0][y0][partIdx] with partIdx equal to 0 or 1 specifies index used to derive GmvdSign[x0][y0] [partIdx] as specified in Table 18. The array indices x0, y0 specify the location (x0, y0) of the top-left luma sample of the considered coding block relative to the top-left luma sample of the picture.

Both components of the GMVD offset GmvdOffset[x0][y0] are derived as follows:
GmvdOffset[x0][y0][partIdx][0]=(GmvdDistance[x0][y0] [partIdx]<<2)*GmvdSign[x0][v0] [partIdx][0]
GmvdOffset[x0][y0][partIdx][1]=(GmvdDistance[x0][y0] [partIdx]<<2)*GmvdSign[x0][y0] [partIdx][1]

. . .

The derivation process for luma motion vectors for geometric partitioning merge mode is changed as follows:

### Derivation Process for Luma Motion Vectors for Geometric Partitioning Merge Mode

This process is only invoked when MergeGpmFlag[xCb][yCb] is equal to 1, where (xCb, yCb) specify the top-left sample of the current luma coding block relative to the top-left luma sample of the current picture.

Inputs to this process are:
a luma location (xCb, yCb) of the top-left sample of the current luma coding block relative to the top-left luma sample of the current picture,
a variable cbWidth specifying the width of the current coding block in luma samples,
a variable cbHeight specifying the height of the current coding block in luma samples.

Outputs of this process are:
the luma motion vectors in 1/16 fractional-sample accuracy mvA and mvB,
the reference indices refIdxA and refIdxB,
the prediction list flags predListFlagA and predListFlagB.

The motion vectors mvA and mvB, the reference indices refIdxA and refIdxB and the prediction list flags predListFlagA and predListFlagB are derived by the following ordered steps:
1. The derivation process for luma motion vectors for merge mode as specified in clause 8.5.2.2 is invoked with the luma location (xCb, yCb), the variables cbWidth and cbHeight inputs, and the output being the luma motion vectors mvL0[0][0], mvL1[0][0], the reference indices refIdxL0, refIdxL1, the prediction list utilization flags predFlagL0[0][0] and predFlagL1[0][0], the bi-prediction weight index bcwIdx and the merging candidate list mergeCandList.
2. The variables m and n, being the merge index for the geometric partition 0 and 1 respectively, are derived using merge_gpm_idx0[xCb][yCb] and merge_gpm_idx1[xCb][yCb] as follows:

$$m = merge\_gpm \_idx 0 [ xCb ] [ yCb ] \qquad ( 637 )$$

$$n = both parts same candidate flag [ x 0 ] [ y 0 ] ? merge gpm idx 0 [ xCb ] [ yCb ] :$$

$$( merge\_gpm \_idx [ xCb ] [ yCb ] + ( ( merge\_gpm \_idx 1 [ xCb ] [ yCb ] >= m ) ? 1 : 0 ) ) \qquad ( 638 )$$

3. Let refIdxL0M and refIdxL1M, predFlagL0M and predFlagL1M, and mvL0M and mvL1M be the reference indices, the prediction list utilization flags and the motion vectors of the merging candidate M at position m in the merging candidate list mergeCandList (M=mergeCandList[m]).
4. The variable X is set equal to (m & 0x01).
5. When predFlagLXM is equal to 0, X is set equal to (1−X).
6. The following applies:

$$mvA [ 0 ] = mvLXM [ 0 ] + GmvdOffset [ x 0 ] [ y 0 ] [ 0 ] [ 0 ] \qquad ( 639 )$$

$$mvA [ 1 ] = mvLXM [ 0 ] + GmvdOffset [ x 0 ] [ y 0 ] [ 0 ] [ 1 ] \qquad ( 640 )$$

$$refIdxA = refIdxLXM \qquad ( 641 )$$

$$predListFlagA = X \qquad ( 642 )$$

7. Let refIdxL0N and refIdxLl1, predFlagL0N and predFlagL1N, and mvL0N and mvL1N be the reference indices, the prediction list utilization flags and the motion vectors of the merging candidate N at position m in the merging candidate list mergeCandList (N=mergeCandList[n]).
8. The variable X is set equal to (n & 0x01).
9. When predFlagLXN is equal to 0, X is set equal to (1−X).
10. The following applies:

$$mvB [ 0 ] = mvLXN [ 0 ] + GmvdOffset [ x 0 ] [ y 0 ] [ 1 ] [ 0 ] \qquad ( 643 )$$

$$mvB [ 1 ] = mvLXN [ 1 ] + GmvdOffset [ x 0 ] [ y 0 ] [ 1 ] [ 1 ] \qquad ( 644 )$$

$$refIdxB = refIdxLXN \qquad ( 645 )$$

$$predListFlagB = X$$

### The Syntax Elements and Associated Binarizations are Changed as Follows:

TABLE 127
Syntax elements and associated binarizations

| 1. Syntax | | 3. Binarization | |
|---|---|---|---|
| structure | 2. Syntax element | 4. Process | 5. Input parameters |
| 6. slice_data( ) | 7. end_of_slice_one_bit | 8. FL | 9. cMax = 1 |
| 10. | 11. . . . | 12. | 13. |
| 14. merge_data( ) | 15. . . . | 16. | 17. |
| | 18. merge_gpm_idx1[ ][ ] | 19. TR | 20. cMax = MaxNumGpmMergeCand − 2, |
| | | | cRiceParam = 0 |
| | 21. gmvd_flag | 22. FL | 23. cMax = 1 |
| | 24. both_parts_same | 25. FL | 26. cMax = 1 |
| | candidate_flag [ ][ ][ ] | | |
| | 27. gmvd_part_flag[ ][ ][ ] | 28. FL | 29. cMax = 1 |
| | 30. gmvd_distance_idx[ ][ ][ ] | 31. TR | 32. cMax = 7, cRiceParam = 0 |
| | 33. . . . | 34. | 35. |

The Assignment of ctxInc to Syntax Elements with Context Coded Bins is Changed as Follows:

TABLE 132
Assignment of ctxInc to syntax elements with context coded bins

| | binIdx | | | | | |
|---|---|---|---|---|---|---|
| Syntax element | 0 | 1 | 2 | 3 | 4 | >=5 |
| end_of_slice_one_bit | terminate | na | na | na | na | na |
| end_of_tile_one_bit | terminate | na | na | na | na | na |
| . . . | | | | | | |
| gmvd_flag | 0 | na | na | na | na | na |
| both_parts_same candidate_flag | 0 | na | na | na | na | na |
| [ ][ ][ ] | | | | | | |
| gmvd_part_flag[ ][ ][ ] | 0 | na | na | na | na | na |
| gmvd_distance_idx[ ][ ][ ] | 0 | bypass | bypass | bypass | bypass | bypass |
| gmvd_direction_idx[ ][ ][ ] | bypass | bypass | bypass | na | na | na |
| . . . | | | | | | |

### 3. PROBLEMS

In the VVC v1 standard, the motion data of a GPM coded block is generated from a regular merge candidate, without motion refinement. Considering the motion refinement before or after the motion compensation (e.g., decoder side motion derivation/refinement such as DMVR, FRUC, template matching TM, and etc.), it would be more efficient if a GPM motion is refined.

### 4. INVENTION

The detailed inventions below should be considered as examples to explain general concepts. These inventions should not be interpreted in a narrow way. Furthermore, these inventions can be combined in any manner.

The term ‘GPM’ may represent a coding method that split one block into two or more sub-regions wherein at least one sub-region is non-rectangular, or non-square, or it couldn't be generated by any of existing partitioning structure (e.g., QT/BT/TT) which splits one block into multiple rectangular sub-regions. In one example, for the GPM coded blocks, one or more weighting masks are derived for a coding block based on how the sub-regions are split, and the final prediction signal of the coding block is generated by a weighted-sum of two or more auxiliary prediction signals associated with the sub-regions.

The term ‘GPM’ may indicate the geometric merge mode (GEO), and/or geometric partition mode (GPM), and/or wedge prediction mode, and/or triangular prediction mode (TPM), and/or a GPM block with motion vector difference (GMVD), and/or a GPM block with motion refinement, and/or any variant based on GPM.

The term ‘block’ may represent a coding block (CB), a CU, a PU, a TU, a PB, a TB.

The phrase “normal/regular merge candidate” may represent the merge candidates generated by the extended merge prediction process (as illustrated in section 3.1). It may also represent any other advanced merge candidates except GEO merge candidates and subblock based merge candidates.

Note that a part/partition of a GPM/GMVD block means a part of a geometric partition in the CU, e.g., the two parts of a GPM block in FIG. 10 are split by a geometrically located straight line. Each part of a geometric partition in the CU is inter-predicted using its own motion, but the transform is performed for the whole CU rather than each part/partition of a GPM block.

It should also be noticed that GPM/GMVD applied to other modes (e.g., AMVP mode) may also use the following methods wherein the motion for merge mode may be replaced by motion for AMVP mode.

It is noticed that in the following descriptions, we use ‘GPM merge list’ as an example. However, the proposed solutions could also be extended to other GPM candidate list, such as GPM AMVP candidate list.

In the disclosure, a merge candidate is called to be “refined” if the motion information of the merge candidate is modified according to information signaled from the encoder or derived at the decoder. For example, a merge candidate may be refined by DVMR, FRUC, TM, MMVD, BDOF and so on.
1. In one example, during the GPM merge list construction process, the GPM motion information may be generated from a refined regular merge candidate.
   1) For example, the refinement process may be conducted on a regular merge candidate list, before the GPM merge list construction process. E.g., the GPM merge list may be constructed based on refined regular merge candidates.
   2) For example, refined L0 motion and/or L1 motion of a regular merge candidate may be used as a GPM merge candidate.
      a) For example, a bi-prediction regular merge candidate may be firstly refined by a decoder side motion derivation/refinement process, and then being used for derivation of GPM motion information.
      b) For example, a uni-prediction regular merge candidate may be firstly refined by a decoder side motion derivation/refinement process, and then being used for derivation of GPM motion information.
   3) Whether to refine a merge candidate or a merge candidate list may depend on the motion information of the candidates.
      a) For example, if a normal merge candidate satisfies the condition of the decoder side motion derivation/refinement method, then this normal merge candidate may be firstly refined by such method, and then being used for derivation of GPM motion information.
2. In one example, after deriving the GPM motion information according to candidate indices (e.g., using the parity and candidate indices to a regular merge candidate list in VVC), the motion information may be further refined by another process.
   1) Alternatively, furthermore, the final prediction of a GPM coded video unit may be dependent on the refined motion information.
   2) For example, the refinement process may be conducted on a GPM merge candidate list, after the GPM merge list construction process. E.g., the GPM merge list may be constructed based on non-refined regular merge candidates.
   3) For example, a GPM merge candidate list (e.g., uni-prediction) is firstly build from a regular merge candidate list, and then any of the GPM merge candidates may be further refined through decoder side motion derivation methods.
3. In one example, a two-stage refinement process may be applied.
   1) For example, a first refinement process may be conducted on a regular merge candidate list, before the GPM merge list construction process. E.g., the GPM merge list may be constructed based on regular merge candidates refined by the first refinement process.
   2) For example, a second refinement process may be conducted on a GPM merge candidate list, after the GPM merge list construction process.
4. In one example, the motion refinement of a GPM block may be conducted for multiple candidates (e.g., corresponding to multiple parts, e.g., both part-0 motion and part-1 motion), simultaneously.
   1) Alternatively, the motion refinement of a GPM block may be conducted for part-0 motion and part-1 motion, respectively.
5. In one example, the motion refinement of a GPM block may be applied to at least one part of a GPM block.
   1) For example, the motion refinement of a GPM block may be applied to both parts of a GPM block.
   2) For example, the motion refinement of a GPM block may be applied to a certain part (not both) of a GPM block, wherein the part index may be predefined or determined by a rule.
6. In one example, the aforementioned motion refinement (e.g., decoder side motion derivation) process may be based on a bilateral matching method (such as DMVR which measures the prediction sample difference between L0 prediction block and L1 prediction block).
   1) For example, the L0/L1 prediction in the bilateral matching of a GPM block may take into account the whole block's information regardless of the GPM split mode information, e.g., a reference block with the same size of the whole GPM block is used a L0/L1 prediction.
      a) Alternatively, the L0/L1 prediction in the bilateral matching of a GPM block may take into account the GPM split mode information, e.g., a reference block with the block shape as same as the part-0/1 associated with a specific GPM split mode may be taken into account.
   2) Alternatively, the aforementioned motion refinement (e.g., decoder side motion derivation) process may be based on a template matching method (e.g., measures the prediction sample difference between template samples in the current picture and template samples in the reference picture, wherein template samples may be the above/left neighbors of the current video unit).
      a) Furthermore, the template may be uni-directional and/or bi-directional.
      b) For example, the template for part-0 and part-1 may be based on different rules.
      c) For example, the template matching process may be applied to a whole block, but the refinement information derived from the template matching process is applied to one part of the block.
      d) For example, the template matching may be applied to a part individually (not applying template matching on the whole block for two parts).
         a. In one example, the shape of a template for a part may depend on the shape of the part.
   3) Furthermore, whether to use bilateral matching method or template matching method to refine a regular merge candidate may be dependent on the motion data of the regular/GPM merge candidate (such as prediction direction, how different the L0 and L1 motion vectors are, POC distances of L0 and L1 motion, and etc.).
   4) Additionally, the refinement process may be applied for GPM motion, without explicit signalling.
      a) Alternatively, whether to allow the refinement or not may be explicitly signalled.
7. In one example, the refined motion may be used for the motion compensation for a GPM block.
   1) Alternatively, the original motion without the refinement may be used for the motion compensation for a GPM block.
8. In one example, the refined motion may be used for the subblock (e.g., 4×4) based motion vector storage for a GPM block.
   1) Alternatively, the original motion without the refinement may be used for the subblock based motion vector storage for a GPM block.
   2) In one example, the refined motion may be used for the deblocking strength determination for a GPM block.
      a) Alternatively, the original motion without the refinement may be used for the deblocking strength determination for a GPM block.
   3) In one example, when generating the AMVP/Merge candidate list for a succeeding block, which may be GPM-coded or non-GPM-coded, the refined motion of a GPM block may be used as 1) a temporal motion vector candidate when the temporal neighbor block is the GPM block, and/or 2) a spatial motion vector candidate when the spatial neighbor block is the GPM block.
      a) Alternatively, the original motion without the refinement may be used in any of the above-mentioned case.
9. In one example, MVD may be added to a refined MV for a block with GMVD mode.
   1) Alternatively, MVD may be added to a non-refined MV for a block with GMVD mode, and then the resulted MV is to be refined.
10. How to conduct the refinement process may be dependent on whether GPM and/or GMVD is used.
   1) For example, less searching points are checked in the refinement process if GPM and/or GMVD is used.

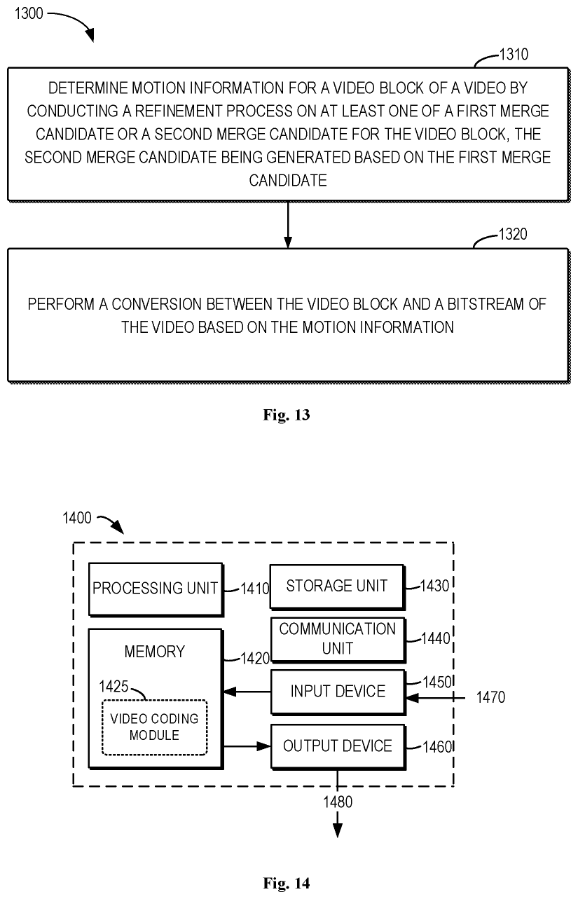

FIG. 13 illustrates a flowchart of a method 1300 for video processing in accordance with some embodiments of the present disclosure. The method 1300 comprises: determining 1310 motion information for a video block of a video by conducting a refinement process on at least one of a first merge candidate or a second merge candidate for the video block, the second merge candidate being generated based on the first merge candidate; and performing 1320 a conversion between the video block and a bitstream of the video based on the motion information.

The method 1300 enables generating motion information for a video block by refining a regular merge candidate. Compared with the conventional solution, the method 1300 in accordance with some embodiments of the present disclosure can advantageously improve the coding performance and efficiency.

In some embodiments, determining motion information for a video block comprises: constructing a merge candidate list for the video block, the merge candidate list comprising at least the second merge candidate generated based on the refinement process conducted on the first merge candidate; and determining the motion information based on the merge candidate list.

For example, the refinement process may be conducted on a regular merge candidate list, before the GPM merge list construction process. That is, the GPM merge list may be constructed based on the refined regular merge candidates.

In some embodiments, determining the motion information based on the merge candidate list comprises: conducting a further refinement process on the second merge candidate to determine the motion information.

In one example, a first refinement process may be conducted on a regular merge candidate list, before the GPM merge list construction process. That is, the GPM merge list may be constructed based on regular merge candidates refined by the first refinement process. Further, a second refinement process may be conducted on a GPM merge candidate list, after the GPM merge list construction process.

In some embodiments, the refinement process comprises refining at least one of: L0 motion information of the first merge candidate; and L1 motion information of the first merge candidate. In some embodiments, the first merge candidate comprises a bi-prediction merge candidate or a uni-prediction merge candidate.

In one example, a bi-prediction regular merge candidate may be firstly refined by a decoder side motion derivation/refinement process. Then, the refined merge candidate can be used for derivation of GPM motion information.

For another example, a uni-prediction regular merge candidate may be firstly refined by a decoder side motion derivation/refinement process. Then, the refined merge candidate can used for derivation of GPM motion information.

In some embodiments, the refinement process is enabled if the first merge candidate satisfies a condition associated with a corresponding refinement method. For example, if a normal merge candidate satisfies the condition of the decoder side motion derivation/refinement method, then this normal merge candidate may be firstly refined by such method, and then being used for derivation of GPM motion information.

In some embodiments, determining motion information for a video block comprises: constructing a merge candidate list for the video block, the merge candidate list comprising at least the second merge candidate generated based on the first merge candidate; and conducting the refinement process on the second merge candidate to determine the motion information for the video block.

In one example, the refinement process may be conducted on a GPM merge candidate list, after the GPM merge list construction process. That is, the GPM merge list may be constructed based on non-refined regular merge candidates.

For another example, a GPM merge candidate list (e.g., uni-prediction) is firstly build from a regular merge candidate list, and then any of the GPM merge candidates may be further refined through decoder side motion derivation methods.

In some embodiments, the video block comprises at least two parts, and wherein the refinement process comprises motion refinement processes simultaneously conducted for the at least two parts. In some embodiments, the video block comprises at least two parts, and wherein the refinement process comprises motion refinement processes conducted for the at least two parts respectively.

In one example, the motion refinement of a GPM block may be conducted for multiple candidates (e.eg., corresponding to multiple parts, e.g., both part-0 motion and part-1 motion), simultaneously. In another example, the motion refinement of a GPM block may be conducted for part-0 motion and part-1 motion, respectively.

In some embodiments, the video block comprises at least two parts, and wherein the refinement process is applied to one or more parts of the at least two parts. In some embodiments, the at least one or more parts are predefined or selected according to a rule.

In one example, the motion refinement of a GPM block may be applied to at least one part of a GPM block. In one example, the motion refinement of a GPM block may be applied to both parts of a GPM block. For another example, the motion refinement of a GPM block may be applied to a certain part (not both) of a GPM block, wherein the part index may be predefined or determined by a rule.

In some embodiments, the refinement process is based on based on bilateral matching. For example, DMVR which measures the prediction sample difference between L0 prediction block and L1 prediction block may be used.

In some embodiments, the video block comprises a geometric partition mode GPM block, and L0 and/or L1 prediction in the bilateral matching of the GPM block is irrelevant to a GPM split mode of the GPM block. For example, a reference block with the same size of the whole GPM block is used a L0/L1 prediction.

In some embodiments, the video block comprises a GPM block, and the L0 and/or L1 prediction in the bilateral matching of the GPM block is based on a GPM split mode of the GPM block. In some embodiments, the refinement process is based on based on template matching.

For example, a reference block with the block shape as same as the part-0/1 associated with a specific GPM split mode may be taken into account.

In some embodiments, a template used in the template matching is uni-directional or bi-directional. In some embodiments, the video block comprises at least two parts, and templates for different parts are determined based on different rules. For example, the template for part-0 and part-1 may be based on different rules.

In some embodiments, the template matching is applied to the whole video block for determining partial motion information associated with one part of the video block. For example, the template matching process may be applied to a whole block, but the refinement information derived from the template matching process is applied to one part of the block.

In some embodiments, the video block comprises at least two parts, and the template matching is applied to a target part of the at least two parts. For example, the template matching may be applied to a part individually, rather than applying template matching on the whole block for two parts). In some embodiments, a shape of a template for the target part is determined based on a shape of the target part.

In some embodiments, whether the refinement process is based on bilateral matching or template matching is determined based on first motion information of the first merge candidate. For example, whether to use bilateral matching method or template matching method to refine a regular merge candidate may be dependent on the motion data of the regular/GPM merge candidate (such as prediction direction, how different the L0 and L1 motion vectors are, POC distances of L0 and L1 motion, and the like).

In some embodiments, the refinement process is enabled when the video block is coded in GPM mode. In some embodiments, the bitstream comprises a flag indicating whether the refinement process is enabled.

In some embodiments, the method 1300 further comprises performing motion compensation for the video block based on the first merge candidate or the second merge candidate. In one example, the refined motion may be used for the motion compensation for a GPM block. Alternatively, the original motion without the refinement may be used for the motion compensation for a GPM block.

In some embodiments, at least one of the first or second merge candidate is used for subblock (e.g., 4×4) based motion vector storage for the video block. In one example, the refined motion may be used for the subblock (e.g., 4×4) based motion vector storage for a GPM block. Alternatively, the original motion without the refinement may be used for the subblock based motion vector storage for a GPM block.

In some embodiments, the first or second motion candidate is used for deblocking strength determination for the video block. In one example, the refined motion may be used for the deblocking strength determination for a GPM block. Alternatively, the original motion without the refinement may be used for the deblocking strength determination for a GPM block.

In some embodiments, the video block comprises a first video block, and the method 1300 further comprises: generating an advanced motion vector predication (AMVP) candidate list or a merge candidate list for a second video block of the video based on the motion information.

In some embodiments, the motion information is further used as: a temporal motion vector candidate if the first video block is a temporal neighbor block of the second video block, or a spatial motion vector candidate if the first video block is a spatial neighbor block of the second video block.

In one example, when generating the AMVP/Merge candidate list for a succeeding block, which may be GPM-coded or non-GPM-coded, the refined motion of a GPM block may be used as 1) a temporal motion vector candidate when the temporal neighbor block is the GPM block, and/or 2) a spatial motion vector candidate when the spatial neighbor block is the GPM block.

In some embodiments, the video block comprises a first video block, and the method 1300 further comprises: generating an AMVP candidate list or a merge candidate list for a second video block based on the first merge candidate for the first video block. That is, the original motion without the refinement may be used in any of the above-mentioned cases.

In some embodiments, the video block is coded in geometric prediction mode with motion vector differences (GMVD) mode, and the method 1300 further comprises: adding a motion vector difference MVD to the motion information.

In some further embodiments, the video block is coded in GMVD mode and the motion information comprises first motion information, and wherein determining motion information for a video block comprises: adding a MVD to second motion information of the first merge candidate to derive third motion information, and determining the first motion information by refining the third motion information.

For example, MVD may be added to a non-refined MV for a block with GMVD mode, and then the resulted MV is to be refined.

In some embodiments, wherein refinement process is based on whether GPM and/or GMVD is used for the video block. In some embodiments, less searching points are checked in the refinement process if GPM and/or GMVD is used.

In some embodiments, the motion information is associated with a target coding mode, and the target coding mode comprises at least one of: geometric merge mode GEO, geometric partition mode GPM, wedge prediction mode, triangular prediction mode TPM, a geometric prediction mode with motion vector differences GMVD, a GPM block with motion refinement, or any any variant based on GPM.

In some embodiments, the refinement process comprises at least one of: a decoder side motion vector refinement DVMR process, a frame-rate up conversion FRUC refinement process, a template matching TM refinement process, a merge mode with motion vector differences MMVD refinement process, a bi-directional optical flow BDOF refinement process, or any other proper refinement processes.

In some embodiments, the conversion comprises decoding the video block from the bitstream.

In some embodiments, the conversion comprises encoding the video block into the bitstream.

Implementations of the present disclosure can be described in view of the following clauses, the features of which can be combined in any reasonable manner.

Clause 1. A method for video processing, comprising:
determining motion information for a video block of a video by conducting a refinement process on at least one of a first merge candidate or a second merge candidate for the video block, the second merge candidate being generated based on the first merge candidate; and
performing a conversion between the video block and a bitstream of the video based on the motion information.

Clause 2. The method of Clause 1, wherein determining motion information for a video block comprises:
constructing a merge candidate list for the video block, the merge candidate list comprising at least the second merge candidate generated based on the refinement process conducted on the first merge candidate; and
determining the motion information based on the merge candidate list.

Clause 3. The method of Clause 2, wherein determining the motion information based on the motion information comprises:
conducting a further refinement process on the second merge candidate to determine the motion information.

Clause 4. The method of Clause 2, wherein the refinement process comprises refining at least one of:
L0 motion information of the first merge candidate; and
L1 motion information of the first merge candidate.

Clause 5. The method of Clause 2, wherein the first merge candidate comprises a bi-prediction merge candidate or a uni-prediction merge candidate.

Clause 6. The method of Clause 2, wherein the refinement process is enabled if the first merge candidate satisfies a condition associated with a corresponding refinement method.

Clause 7. The method of Clause 1, wherein determining motion information for a video block comprises:
constructing a merge candidate list for the video block, the merge candidate list comprising at least the second merge candidate generated based on the first merge candidate; and
conducting the refinement process on the second merge candidate to determine the motion information for the video block.

Clause 8. The method of any of Clauses 1-7, wherein the video block comprises at least two parts, and wherein the refinement process comprises motion refinement processes simultaneously conducted for the at least two parts.

Clause 9. The method of any of Clauses 1-7, wherein the video block comprises at least two parts, and wherein the refinement process comprises motion refinement processes conducted for the at least two parts respectively.

Clause 10. The method of Clause 1, wherein the video block comprises at least two parts, and wherein the refinement process is applied to one or more parts of the at least two parts.

Clause 11. The method of Clause 10, wherein the at least one or more parts are predefined or selected according to a rule.

Clause 12. The method of any of Clauses 1-7, wherein the refinement process is based on bilateral matching.

Clause 13. The method of Clause 12, wherein the video block comprises a geometric partition mode (GPM) block, and L0 and/or L1 prediction in the bilateral matching of the GPM block is irrelevant to a GPM split mode of the GPM block.

Clause 14. The method of Clause 12, wherein the video block comprises a GPM block, and the L0 and/or L1 prediction in the bilateral matching of the GPM block is based on a GPM split mode of the GPM block.

Clause 15. The method of any of Clauses 1-7, wherein the refinement process is based on based on template matching.

Clause 16. The method of Clause 15, wherein a template used in the template matching is uni-directional or bi-directional.

Clause 17. The method of Clause 15, wherein the video block comprises at least two parts, and templates for different parts are determined based on different rules.

Clause 18. The method of Clause 15, wherein the template matching is applied to the whole video block for determining partial motion information associated with one part of the video block.

Clause 19. The method of Clause 15, wherein the video block comprises at least two parts, and the template matching is applied to a target part of the at least two parts.

Clause 20. The method of Clause 19, wherein a shape of a template for the target part is determined based on a shape of the target part.

Clause 21. The method of any of Clauses 1-7, wherein whether the refinement process is based on bilateral matching or template matching is determined based on first motion information of the first merge candidate.

Clause 22. The method of any of Clauses 1-7, wherein the refinement process is enabled if the video block is coded in GPM mode.

Clause 23. The method of any of Clauses 1-7, wherein the bitstream comprises a flag indicating whether the refinement process is enabled.

Clause 24. The method of any of Clause 1-7, further comprising:
performing motion compensation for the video block based on the first merge candidate or the second merge candidate.

Clause 25. The method of any of Clauses 1-7, wherein at least one of the first or second merge candidate is used for subblock based motion vector storage for the video block.

Clause 26. The method of any of Clauses 1-7, wherein the first or second motion candidate is used for deblocking strength determination for the video block.

Clause 27. The method of any of Clauses 1-7, wherein the video block comprises a first video block, and the method further comprises:
generating an advanced motion vector predication (AMVP) candidate list or a merge candidate list for a second video block of the video based on the motion information.

Clause 28. The method of Clause 27, wherein the motion information is further used as:
a temporal motion vector candidate if the first video block is a temporal neighbor block of the second video block, or
a spatial motion vector candidate if the first video block is a spatial neighbor block of the second video block.

Clause 29. The method of any of Clauses 1-7, wherein the video block comprises a first video block, and the method further comprises:
generating an AMVP candidate list or a merge candidate list for a second video block of the video block based on the first merge candidate for the first video block.

Clause 30. The method of any of Clauses 1-7, wherein the video block is coded in geometric prediction mode with motion vector differences (GMVD) mode, and the method further comprises:
adding a motion vector difference (MVD) to the motion information.

Clause 31. The method of any of Clauses 1-7, wherein the video block is coded in GMVD mode and the motion information comprises first motion information, and wherein determining motion information for a video block comprises:
adding a MVD to second motion information of the first merge candidate to derive third motion information, and
determining the first motion information by refining the third motion information.

Clause 32. The method of any of Clauses 1-7, wherein refinement process is based on whether GPM and/or GMVD is used for the video block.

Clause 33. The method of Clause 32, wherein less searching points are checked in the refinement process if GPM and/or GMVD is used.

Clause 34. The method of any of Clauses 1-7, wherein the motion information is associated with a target coding mode, and the target coding mode comprises at least one of:
geometric merge mode (GEO),
geometric partition mode (GPM),
wedge prediction mode,
triangular prediction mode (TPM),
geometric prediction mode with motion vector differences (GMVD), or
a GPM block with motion refinement.

Clause 35. The method of any of Clauses 1-7, wherein the refinement process comprises at least one of:
a decoder side motion vector refinement (DVMR) process,
a frame-rate up conversion (FRUC) refinement process,
a template matching (TM) refinement process,
a merge mode with motion vector differences (MMVD) refinement process, or
a bi-directional optical flow (BDOF) refinement process.

Clause 36. The method of any of Clauses 1-35, wherein the conversion comprises decoding the video block from the bitstream.

Clause 37. The method of any of Clauses 1-35, wherein the conversion comprises encoding the video block into the bitstream.

Clause 38. An apparatus for processing video data comprising a processor and a non-transitory memory with instructions thereon, wherein the instructions upon execution by the processor, cause the processor to:
determine motion information for a video block of a video by conducting a refinement process on at least one of a first merge candidate or a second merge candidate for the video block, the second merge candidate being generated based on the first merge candidate; and
perform a conversion between the video block and a bitstream of the video based on the motion information.

Clause 39. A non-transitory computer-readable storage medium storing instructions that cause a processor to:
determine motion information for a video block of a video by conducting a refinement process on at least one of a first merge candidate or a second merge candidate for the video block, the second merge candidate being generated based on the first merge candidate; and
perform a conversion between the video block and a bitstream of the video based on the motion information.

Clause 40. A non-transitory computer-readable recording medium storing a bitstream of a video which is generated by a method performed by a video processing apparatus, wherein the method comprises:
determining motion information for a video block of a video by conducting a refinement process on at least one of a first merge candidate or a second merge candidate for the video block, the second merge candidate being generated based on the first merge candidate; and
generating the bitstream based on the motion information.

Clause 41. A method for storing bitstream of a video, comprising:
determining motion information for a video block of a video by conducting a refinement process on at least one of a first merge candidate or a second merge candidate for the video block, the second merge candidate being generated based on the first merge candidate;
generating the bitstream based on the motion information; and
storing the bitstream in a non-transitory computer-readable recording medium.

### Example Device

FIG. 14 illustrates a block diagram of a computing device 1400 in which various embodiments of the present disclosure can be implemented. The computing device 1400 may be implemented as or included in the source device 110 (or the video encoder 114 or 200) or the destination device 120 (or the video decoder 124 or 300).

It would be appreciated that the computing device 1400 shown in FIG. 14 is merely for purpose of illustration, without suggesting any limitation to the functions and scopes of the embodiments of the present disclosure in any manner.

As shown in FIG. 14, the computing device 1400 includes a general-purpose computing device 1400. The computing device 1400 may at least comprise one or more processors or processing units 1410, a memory 1420, a storage unit 1430, one or more communication units 1440, one or more input devices 1450, and one or more output devices 1460.

In some embodiments, the computing device 1400 may be implemented as any user terminal or server terminal having the computing capability. The server terminal may be a server, a large-scale computing device or the like that is provided by a service provider. The user terminal may for example be any type of mobile terminal, fixed terminal, or portable terminal, including a mobile phone, station, unit, device, multimedia computer, multimedia tablet, Internet node, communicator, desktop computer, laptop computer, notebook computer, netbook computer, tablet computer, personal communication system (PCS) device, personal navigation device, personal digital assistant (PDA), audio/video player, digital camera/video camera, positioning device, television receiver, radio broadcast receiver, E-book device, gaming device, or any combination thereof, including the accessories and peripherals of these devices, or any combination thereof. It would be contemplated that the computing device 1400 can support any type of interface to a user (such as “wearable” circuitry and the like).

The processing unit 1410 may be a physical or virtual processor and can implement various processes based on programs stored in the memory 1420. In a multi-processor system, multiple processing units execute computer executable instructions in parallel so as to improve the parallel processing capability of the computing device 1400. The processing unit 1410 may also be referred to as a central processing unit (CPU), a microprocessor, a controller or a microcontroller.

The computing device 1400 typically includes various computer storage medium. Such medium can be any medium accessible by the computing device 1400, including, but not limited to, volatile and non-volatile medium, or detachable and non-detachable medium. The memory 1420 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 1430 may be any detachable or non-detachable medium and may include a machine-readable medium such as a memory, flash memory drive, magnetic disk or another other media, which can be used for storing information and/or data and can be accessed in the computing device 1400.

The computing device 1400 may further include additional detachable/non-detachable, volatile/non-volatile memory medium. Although not shown in FIG. 14, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more data medium interfaces.

The communication unit 1440 communicates with a further computing device via the communication medium. In addition, the functions of the components in the computing device 1400 can be implemented by a single computing cluster or multiple computing machines that can communicate via communication connections. Therefore, the computing device 1400 can operate in a networked environment using a logical connection with one or more other servers, networked personal computers (PCs) or further general network nodes.

The input device 1450 may be one or more of a variety of input devices, such as a mouse, keyboard, tracking ball, voice-input device, and the like. The output device 1460 may be one or more of a variety of output devices, such as a display, loudspeaker, printer, and the like. By means of the communication unit 1440, the computing device 1400 can further communicate with one or more external devices (not shown) such as the storage devices and display device, with one or more devices enabling the user to interact with the computing device 1400, or any devices (such as a network card, a modem and the like) enabling the computing device 1400 to communicate with one or more other computing devices, if required. Such communication can be performed via input/output (I/O) interfaces (not shown).

In some embodiments, instead of being integrated in a single device, some or all components of the computing device 1400 may also be arranged in cloud computing architecture. In the cloud computing architecture, the components may be provided remotely and work together to implement the functionalities described in the present disclosure. In some embodiments, cloud computing provides computing, software, data access and storage service, which will not require end users to be aware of the physical locations or configurations of the systems or hardware providing these services. In various embodiments, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding data may be stored on a server at a remote position. The computing resources in the cloud computing environment may be merged or distributed at locations in a remote data center. Cloud computing infrastructures may provide the services through a shared data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The computing device 1400 may be used to implement video encoding/decoding in embodiments of the present disclosure. The memory 1420 may include one or more video coding modules 1425 having one or more program instructions. These modules are accessible and executable by the processing unit 1410 to perform the functionalities of the various embodiments described herein.

In the example embodiments of performing video encoding, the input device 1450 may receive video data as an input 1470 to be encoded. The video data may be processed, for example, by the video coding module 1425, to generate an encoded bitstream. The encoded bitstream may be provided via the output device 1460 as an output 1480.

In the example embodiments of performing video decoding, the input device 1450 may receive an encoded bitstream as the input 1470. The encoded bitstream may be processed, for example, by the video coding module 1425, to generate decoded video data. The decoded video data may be provided via the output device 1460 as the output 1480.

While this disclosure has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting.

1-41. (canceled)

42. A method for video processing, comprising:
determining motion information for a video block of a video by conducting a refinement process on at least one of a first merge candidate or a second merge candidate for the video block, the second merge candidate being generated based on the first merge candidate; and
performing a conversion between the video block and a bitstream of the video based on the motion information.

43. The method of claim 42, wherein determining motion information for a video block comprises:
constructing a merge candidate list for the video block, the merge candidate list comprising at least the second merge candidate generated based on the refinement process conducted on the first merge candidate; and
determining the motion information based on the merge candidate list.

44. The method of claim 43, wherein determining the motion information based on the motion information comprises: conducting a further refinement process on the second merge candidate to determine the motion information; or
wherein the refinement process comprises refining at least one of: L0 motion information of the first merge candidate; and L1 motion information of the first merge candidate; or
wherein the first merge candidate comprises a bi-prediction merge candidate or a uni-prediction merge candidate; or
wherein the refinement process is enabled if the first merge candidate satisfies a condition associated with a corresponding refinement method.

45. The method of claim 42, wherein determining motion information for a video block comprises:
constructing a merge candidate list for the video block, the merge candidate list comprising at least the second merge candidate generated based on the first merge candidate; and
conducting the refinement process on the second merge candidate to determine the motion information for the video block.

46. The method of claim 42, wherein the video block comprises at least two parts, and wherein the refinement process comprises motion refinement processes simultaneously conducted for the at least two parts; or
wherein the video block comprises at least two parts, and wherein the refinement process comprises motion refinement processes conducted for the at least two parts respectively; or
wherein the video block comprises at least two parts, and wherein the refinement process is applied to one or more parts of the at least two parts.

47. The method of claim 46, wherein the at least one or more parts are predefined or selected according to a rule.

48. The method of claim 42, wherein the refinement process is based on bilateral matching.

49. The method of claim 48, wherein the video block comprises a geometric partition mode (GPM) block, and L0 and/or L1 prediction in the bilateral matching of the GPM block is irrelevant to a GPM split mode of the GPM block; or
wherein the video block comprises a GPM block, and the L0 and/or L1 prediction in the bilateral matching of the GPM block is based on a GPM split mode of the GPM block.

50. The method of claim 42, wherein the refinement process is based on based on template matching.

51. The method of claim 50, wherein a template used in the template matching is uni-directional or bi-directional; or
wherein the video block comprises at least two parts, and templates for different parts are determined based on different rules; or
wherein the template matching is applied to the whole video block for determining partial motion information associated with one part of the video block; or
wherein the video block comprises at least two parts, and the template matching is applied to a target part of the at least two parts.

52. The method of claim 51, wherein a shape of a template for the target part is determined based on a shape of the target part.

53. The method of claim 42, wherein whether the refinement process is based on bilateral matching or template matching is determined based on first motion information of the first merge candidate; or
wherein the refinement process is enabled if the video block is coded in GPM mode; or
wherein the bitstream comprises a flag indicating whether the refinement process is enabled;
wherein at least one of the first or second merge candidate is used for subblock based motion vector storage for the video block; or
wherein the first or second motion candidate is used for deblocking strength determination for the video block; or
wherein the method further comprises: performing motion compensation for the video block based on the first merge candidate or the second merge candidate; or
wherein the video block comprises a first video block, and the method further comprises:
generating an advanced motion vector predication (AMVP) candidate list or a merge candidate list for a second video block of the video based on the motion information.

54. The method of claim 53, wherein the motion information is further used as:
a temporal motion vector candidate if the first video block is a temporal neighbor block of the second video block, or
a spatial motion vector candidate if the first video block is a spatial neighbor block of the second video block.

55. The method of claim 42, wherein the video block comprises a first video block, and the method further comprises:
generating an AMVP candidate list or a merge candidate list for a second video block of the video block based on the first merge candidate for the first video block.

56. The method of claim 42, wherein the video block is coded in geometric prediction mode with motion vector differences (GMVD) mode, and the method further comprises:
adding a motion vector difference (MVD) to the motion information.

57. The method of claim 42, wherein the video block is coded in GMVD mode and the motion information comprises first motion information, and wherein determining motion information for a video block comprises:
adding a MVD to second motion information of the first merge candidate to derive third motion information, and
determining the first motion information by refining the third motion information.

58. The method of claim 42, wherein the motion information is associated with a target coding mode, and the target coding mode comprises at least one of:
geometric merge mode (GEO),
geometric partition mode (GPM),
wedge prediction mode,
triangular prediction mode (TPM),
geometric prediction mode with motion vector differences (GMVD), or
a GPM block with motion refinement; or
wherein the refinement process comprises at least one of:
a decoder side motion vector refinement (DVMR) process,
a frame-rate up conversion (FRUC) refinement process,
a template matching (TM) refinement process,
a merge mode with motion vector differences (MMVD) refinement process, or
a bi-directional optical flow (BDOF) refinement process.

59. The method of claim 42, wherein the conversion comprises:
decoding the video block from the bitstream; or encoding the video block into the bitstream.

60. An apparatus for processing video data comprising a processor and a non-transitory memory with instructions thereon, wherein the instructions upon execution by the processor, cause the processor to:
determine motion information for a video block of a video by conducting a refinement process on at least one of a first merge candidate or a second merge candidate for the video block, the second merge candidate being generated based on the first merge candidate; and
perform a conversion between the video block and a bitstream of the video based on the motion information.

60. A non-transitory computer-readable storage medium storing instructions that cause a processor to:
determine motion information for a video block of a video by conducting a refinement process on at least one of a first merge candidate or a second merge candidate for the video block, the second merge candidate being generated based on the first merge candidate; and
perform a conversion between the video block and a bitstream of the video based on the motion information.
